(19) United States
(12) Patent Application Publication
(10) Pub. No.: US 2014/0274967 A1
(43) Pub. Date: Sep. 18, 2014

(54) Polyisoprenyl derivatives and uses thereof

(71) Applicant: COYOTE PHARMACEUTICALS, INC., Menlo Park, CA (US)

(72) Inventors: William Boyle, Menlo Park, CA (US); Naoki Nakayama, Menlo Park, CA (US)

(73) Assignee: COYOTE PHARMACEUTICALS, INC., MENLO PARK, CA (US)

(21) Appl. No.: 13/815,831

(22) Filed: Mar. 15, 2013

(51) Int. Cl. C07F 9/40

(52) U.S. Cl. CPC C07F 9/4015
USPC 514/108; 514/120; 558/161; 558/182

(57) ABSTRACT

This invention relates generally to polyisoprenyl phosphonate derivatives pharmaceutical compositions comprising polyisoprenyl phosphonate derivatives, and uses thereof.

### FIELD OF THE INVENTION

This invention relates generally to polyisoprenyl phosphonate derivatives pharmaceutical compositions comprising polyisoprenyl phosphonate derivatives, and uses thereof.

### STATE OF THE ART

Geranylgeranyl acetone is an acyclic isoprenoid compound with a retinoid skeleton that has been shown to induce expression of heat shock proteins in various tissue types. GGA is a known anti-ulcer drug used commercially and in clinical situations. GGA is also used for neurodegenerative diseases. See, WO 2012/031028 (incorporated herein by reference).

Neurodegeneration is often the result of increased age, sporadic mutations, disease, and/or protein aggregation in neural cells. Neurodegenerative diseases are often characterized by a progressive neurodegeneration of tissues of the nervous system and a loss of functionality of the neurons themselves. One commonality seen among most neurodegenerative diseases is the accumulation of protein aggregates intracellularly or in the extracellular space between neurons.

There is a need for more effective therapies for neural and neurodegenerative diseases. There is also a need for more effective therapies for the treatment of osteopenia, including osteoporosis.

### SUMMARY OF THE INVENTION

This invention relates generally to polyisoprenyl phosphonate derivatives pharmaceutical compositions comprising polyisoprenyl phosphonate derivatives, and uses thereof. In some aspects, this invention relates to methods for inhibiting neural death, increasing neural activity and for treating osteopenia, including osteoporosis, or reducing the negative effects of osteopenia with the derivatives and pharmaceutical compositions provided herein. It is contemplated that these derivatives may possess one or more properties such as increased blood brain barrier penetration, enhanced activity, improved serum half-life, and/or lower toxicity.

This invention provides methods for treating osteopenia including osteoporosis with compounds provided herein and/or utilized herein. In one aspect, this invention provides methods for treating osteopenia or reducing the negative effects of bone loss comprising administering to a subject in need thereof a therapeutically effective amount of compounds provided herein and/or utilized herein. As used herein, subject or patient refers to a mammal, particularly preferably humans.

In some embodiments, treating osteopenia includes without limitation, modulating osteoclast and/or osteoblast function, and preferably, decreasing osteoclast function in diseases such as osteoporosis, hypercalcemia of malignancy, cancer metastasis to the bone, arthritis, Rheumatoid arthritis, bone loss due to immobilization, Paget's disease of the bone, bone loss due to hyperparathyroidism and other metabolic diseases, bone loss due to treatment with corticosteroids, bone loss due to treatment with aromatase inhibitors, periodontal disease, prosthetic loosening and the like. In some embodiments, treating osteopenia includes treating osteoporosis.

In another aspect, this invention provides methods for treating a subject who undergoes or has undergone a bone grafting procedure, where the bone grafting procedure is autologous (with bone harvested from the patient's own body) includes an allograft (with cadaveric bone usually obtained from a bone bank), or includes a synthetic graft. The methods described herein can be used to treat a subject before, during and/or after a bone grafting procedure.

In another aspect, this invention provides methods for decreasing osteoclast activity and decreasing bone resorption comprising contacting an osteoclast with an effective amount of compounds provided herein and/or utilized herein. In another aspect, this invention provides methods for shifting the balance between osteoclast and osteoblast activity comprising contacting an osteoclast and/or osteoblast with an effective amount of compounds provided herein and/or utilized herein. In one embodiment, the method further comprises decreasing osteoclast activity and/or increasing osteoblast activity, and/or decreasing bone resorption. In another aspect, this invention provides a method of blocking osteoclast differentiation and/or osteoclast activation of bone resorption, the method comprising contacting an osteoclast with an effective amount of compounds provided herein and/or utilized herein.

In another aspect, this invention provides a method for inhibiting loss of bone density in a patient in need thereof comprising administering to the patient an effective amount of compounds provided herein and/or utilized herein. In another aspect, this invention provides a method for inhibiting bone fracture in a patient at risk thereof which bone fracture arises at least in part from pathological bone loss comprising administering to the patient an effective amount of compounds provided herein and/or utilized herein. In one embodiment, the bone fracture is fracture of the hip. In one embodiment, the bone fracture is fracture of the vertebrae.

In another aspect, this invention provides a method for inhibiting bone loss and/or facilitating bone growth in a patient at a risk of loss of bone density, comprising administering to the patient an effective amount of compounds provided herein and/or utilized herein. Without being bound by theory, it is contemplated that the methods and compositions provided herein can increase bone formation and/or reduce bone resorption.

Preferably, the compounds provided herein and/or utilized herein includes the all-trans (hereinafter “trans”) form or substantially the trans form. As used herein, “substantially” in the context of cis/trans configurations refers to at least 80%, more preferably at least 90%, yet more preferably at least 95%, and most preferably at least 99% of the desired configuration, which can include at least 80%, more preferably at least 90%, yet more preferably at least 95%, and most preferably at least 99% of the trans isomer. In certain embodiments, at least 90%, more preferably, at least 95%, yet more preferably at least 99%, and most preferably, at least 99.5% of the compounds provided herein and/or utilized herein is present as an all trans isomer

In certain aspects of the invention, the composition provided inhibiting neural death, increasing neural activity, and/or for reducing one or more negative effects of neurodegeneration. In one embodiment, the composition includes a compound of Formula (I), (II) or (IIA):

[chemical structure]

or a pharmaceutically acceptable salt thereof, and at least one pharmaceutically acceptable excipient,
wherein
   R¹ is C₅-C₂₀ alkyl or C₅-C₂₀ alkenyl optionally substituted with 1-3 C₆-C₂₀ arylene groups in the chain and that is optionally substituted with 1-3 halo, trifluoromethyl, —OR⁷, —P(═O)(OR⁸)(OR⁹) or —NR¹⁰R¹¹ groups;
   R² is (C₅-C₂₀)alkyl or C₅-C₂₀ alkenyl optionally substituted with 1-3 C₆-C₂₀ aryl groups, which aryl group(s) are optionally substituted with 1-3 halo, trifluoromethyl, —OR⁷, —P(═O)(OR⁸)(OR⁹) or —NR¹⁰R¹¹ groups;
   each R³, R⁴, R⁵, and R⁶ is independently OH or C₁-C₆ alkoxy;
   each R⁷, R⁸ and R⁹ is independently hydrogen, C₁-C₆ alkyl or C₆-C₂₀ aryl; and
   each R¹⁰ and R¹¹ is independently hydrogen, C₁-C₆ alkyl or C₆-C₂₀ aryl; or R¹⁰ and R¹¹ together with the nitrogen to which they are attached form a C₃-C₇ heterocycle;
   wherein each aryl group of R⁷, R⁸, R⁹, R¹⁰ and R¹¹ is optionally substituted with 1-3 C₁-C₆ alkyl, C₁-C₆ alkoxy, C₁-C₆ alkanoyl, C₁-C₆ alkanoyloxy, C₁-C₆ alkoxycarbonyl, halo, cyano, nitro, carboxy, trifluoromethyl, trifluoromethoxy, NR¹²R¹³, or S(O)₂NR¹²R¹³ groups, wherein each R¹² and R¹³ is independently hydrogen or C₁-C₆ alkyl;
   R¹⁴ and R¹⁵ are independently selected from the group consisting of hydrogen, C₁-C₆ alkyl, C₃-C₇ cycloalkyl, C₂-C₆ alkenyl, C₁-C₆ alkynyl, optionally substituted C₆-C₂₀ aryl, optionally substituted C₆-C₂₀ aryl-C₁-C₆alkyl, optionally substituted heteroaryl and optionally substituted heteroaryl-C₁-C₆ alkyl, each heteroaryl having 2-14 ring carbon atoms and 1-6 ring heteroatoms selected preferably from N, O, S, and P, wherein each substituted aryl or substituted heteroaryl is independently substituted with 1-3 substituents selected from —OH, halo, C₁-C₆ alkyl, C₁-C₆ alkoxy, —NO₂, and —NR¹⁰R¹¹ groups; or R¹⁴ and R¹⁵ together with the carbon atom they are attached to form a C₃-C₇ cycloalkyl ring optionally substituted with 1-3 C₁-C₆ alkyl groups;
   R¹⁶ and R¹⁷ independently are hydrogen or C₁-C₆ alkyl;
   each R¹⁸ and R¹⁹ are independently selected from the group consisting of a hydrogen, C₁-C₆ alkyl, and a group of Formula (III):

[chemical structure]

wherein R¹⁴-R¹⁷ and n are as defined as herein;
Y is —P(═O)(OR¹⁸)(OR¹⁹), —CO₂R²⁰ or —SO₂OR²⁰, wherein R²⁰ is selected from the group consisting of a hydrogen and C₁-C₆ alkyl;
Z is

[chemical structure]

wherein R²¹ is hydrogen or C₁-C₆ alkyl; A is C₁-C₅ alkylene which may have a substituent selected from —OH, halo, C₁-C₆ alkyl, and C₁-C₆ alkoxy groups on each carbon;
r is 0, 1, 2, 3, 4 or 5; and
n is 0, 1, 2, 3, 4 or 5.

In certain embodiments, the composition includes a compound of Formula (II), where the compound of Formula (II) is of Formula (IIA):

[chemical structure]

wherein R¹⁴, R¹⁵, R¹⁸ and R¹⁹ are defined herein. In some embodiments, both the Y moieties attached to the carbon atom of formula (IIB) are not a sulfonate or a salt or ester thereof.

In certain embodiments, the composition includes a compound of Formula (II) that is selected from the group consisting of:

[chemical structure]

and the corresponding ethyl and other C₁-C₆ alkyl esters. “Corresponding” esters refer to ethyl esters and the likes of methyl esters and/or phosphonic and/or carboxylic acids shown herein.

In certain embodiments, the composition includes a compound of Formula (I) that is selected from the group consisting of:

[chemical structure]

and the corresponding ethyl and other C₁-C₆ alkyl esters.

In further aspects of the invention, a compound is provided of Formula (II):

[chemical structure]

or a pharmaceutically acceptable salt thereof,
wherein
   R¹⁴ and R¹⁵ are independently selected from the group consisting of hydrogen, C₁-C₆ alkyl, C₃-C₇ cycloalkyl, C₂-C₆ alkenyl, C₁-C₆ alkynyl, optionally substituted C₆-C₂₀ aryl, optionally substituted C₆-C₂₀ aryl-C₁-C₆ alkyl, optionally substituted heteroaryl and optionally substituted heteroaryl C₁-C₆ alkyl, each heteroaryl having 2-14 ring carbon atoms and 1-6 ring heteroatoms selected preferably from N, O, S, and P, wherein each substituted aryl or substituted heteroaryl is independently substituted with 1-3 substituents selected from —OH, halo, C₁-C₆ alkyl, C₁-C₆ alkoxy, —NO₂, and —NR¹⁰R¹¹ groups; or
   R¹⁴ and R¹⁵ with the carbon atom they are attached to form a C₃-C₇ cycloalkyl ring optionally substituted with 1-3 C₁-C₆ alkyl groups;
   R¹⁶ and R¹⁷ independently are hydrogen, methyl or C₂-C₆ alkyl, provided that, when one of R¹⁸ and R¹⁹ is not:

[chemical structure]

and each of R¹⁶ and R¹⁷ is methyl, then R¹⁴ and R¹⁵ are defined as follows: R¹⁴ and R¹⁵ together with the carbon atom they are attached to form a C₅-C₇ cycloalkyl optionally substituted with 1-3 C₁-C₆ alkyl groups;
R¹⁸ and R¹⁹ are independently selected from the group consisting of a hydrogen, C₁-C₆ alkyl and a group of Formula (III):

[chemical structure]

Y is —P(═O)(OR¹⁸)(OR¹⁹) or
   —CO₂R²⁰, wherein R²⁰ is selected from the group consisting of hydrogen and C₁-C₆ alkyl;
Z is

[chemical structure]

wherein R²¹ is hydrogen or C₁-C₆ alkyl; A is C₁-C₅ alkylene which may have a substituent selected from —OH, halo, C₁-C₆ alkyl, and C₁-C₆ alkoxy groups on each carbon;
r is 0, 1, 2, 3, 4 or 5; and
n is 0, 1, 2, 3, 4 or 5.

In further aspects of the invention, a composition is provided comprising the compound of Formula (II), or a pharmaceutically acceptable salt thereof, and at least one pharmaceutically acceptable excipient, provided that, when one of R¹⁸ and R¹⁹ is not:

[chemical structure]

and each of R¹⁶ and R¹⁷ is methyl, then R¹⁴ and R¹⁵ together with the carbon atom they are attached to form a C₅-C₇ cycloalkyl optionally substituted with 1-3 C₁-C₆ alkyl groups, and the other variables are defined as above.

In still further aspects of the invention, a method of: inhibiting neural death, increasing neural activity, and/or of reducing one or more negative effects of neurodegeneration, or treating osteopenia and/or reducing one or more negative effects of osteopenia is provided comprising administering the compound of Formula (II), a pharmaceutically acceptable salt thereof, or a composition comprising the compound of Formula (II) to a patient in need thereof, provided that, when one of R¹⁸ and R¹⁹ is not:

[chemical structure]

and each of R¹⁶ and R¹⁷ is methyl, then R¹⁴ and R¹⁵ together with the carbon atom they are attached to form a C₅-C₇ cycloalkyl optionally substituted with 1-3 C₁-C₆ alkyl groups.

In some embodiments the method comprises administering an effective amount of a compound of formula (I) or (II) selected from the group consisting of:

[chemical structure]

and the corresponding ethyl and other C₁-C₆ alkyl esters.

In another aspect provided herein are polyisoprenyl conjugates of bisphosphonate drugs useful for treating osteopenia including osteoporosis. Non-limiting examples of such drugs include those shown below.

[chemical structure]

Nitrogenous Bisphosphonates

[chemical structure]

Preferred neural or a neurodegenerative diseases, and one or more negative effects of neurodegeneration treated or improved according to this invention are described herein below.

### DETAILED DESCRIPTION

It is to be understood that this invention is not limited to particular embodiments described. It is also to be understood that the terminology used herein is for the purpose of describing particular embodiments only, and is not intended to be limiting, since the scope of the present invention will be limited only by the appended claims.

It must be noted that as used herein and in the appended claims, the singular forms “a”, “an”, and “the” include plural referents unless the context clearly dictates otherwise. Thus, for example, reference to “an excipient” includes a plurality of excipients.

### DEFINITIONS

Unless defined otherwise, all technical and scientific terms used herein have the same meaning as commonly understood by one of ordinary skill in the art to which this invention belongs. As used herein the following terms have the following meanings.

As used herein, the term “comprising” or “comprises” is intended to mean that the compositions and methods include the recited elements, but not excluding others. “Consisting essentially of” when used to define compositions and methods, shall mean excluding other elements of any essential significance to the combination for the stated purpose. Thus, a composition consisting essentially of the elements as defined herein would not exclude other materials or steps that do not materially affect the basic and novel characteristic(s) of the claimed invention. “Consisting of” shall mean excluding more than trace elements of other ingredients and substantial method steps. Embodiments defined by each of these transition terms are within the scope of this invention.

The term “about” when used before a numerical designation, e.g., temperature, time, amount, and concentration, including range, indicates approximations which may vary by (+) or (−) 10%, 5% or 1%.

As used herein, the term “polyisoprenyl phosphonate” or “polyisoprenyl phosphonate derivative” refers to any of the compounds of Formula (I), (II) or (IIA) described herein.

As used herein, Cₘ-Cₙ, such as C₁-C₁₀, C₁-C₆, or C₁-C₄ when used before a group refers to that group containing m to n carbon atoms.

The term “alkyl” refers to monovalent saturated aliphatic hydrocarbyl groups having from 1 to 25 carbon atoms (i.e., C₁-C₂₅ alkyl) or 1 to 6 carbon atoms (i.e., C₁-C₆ alkyl), or 1 to 4 carbon atoms. This term includes, by way of example, linear and branched hydrocarbyl groups such as methyl (CH₃—), ethyl (CH₃CH₂—), n-propyl (CH₃CH₂CH₂—), isopropyl ((CH₃)₂CH—), n-butyl (CH₃CH₂CH₂CH₂—), isobutyl ((CH₃)₂CHCH₂—), sec-butyl ((CH₃)(CH₃CH₂)CH—), t-butyl ((CH₃)₃C—), n-pentyl (CH₃CH₂CH₂CH₂CH₂—), and neopentyl ((CH₃)₃CCH₂—). Alkyl substituted with a substituent refers to an alkyl group that is substituted with up to 5, preferably up to 4, and still more preferably up to 3 substituents, and includes alkyl groups substituted with 1 or 2 substituents.

The term “alkenyl” refers to monovalent aliphatic hydrocarbyl groups having from 2 to 25 carbon atoms or 2 to 6 carbon atoms and 1 or more, preferably 1, carbon carbon double bond. Examples of alkenyl include vinyl, allyl, dimethyl allyl, and the like.

The term “alkoxy” refers to —O-alkyl, where alkyl is as defined above.

The terms “alkanoyl” and “acyl” refer to —C(O)-alkyl, where alkyl is as defined above.

The term “alkanoyloxy” refers to —OC(O)-alkyl, where alkyl is as defined above.

The term “alkoxycarbonyl” refers to —CO₂-alkyl, where alkyl is as defined above.

The term “alkynyl” refers to monovalent aliphatic hydrocarbyl groups having from 2 to 10 carbon atoms or 2 to 6 carbon atoms and 1 or more, preferably 1, carbon carbon triple bond —(C≡C)—. Examples of alkynyl include ethynyl, propargyl, dimethylpropargyl, and the like.

The term “aryl” refers to a monovalent, aromatic mono- or bicyclic ring having 6-10 ring carbon atoms. Examples of aryl include phenyl and naphthyl. The condensed ring may or may not be aromatic provided that the point of attachment is at an aromatic carbon atom. For example, and without limitation, the following is an aryl group:

[chemical structure]

The term “cycloalkyl” refers to a monovalent, preferably saturated, hydrocarbyl mono-, bi-, or tricyclic ring having 3-12 ring carbon atoms. While cycloalkyl, refers preferably to saturated hydrocarbyl rings, as used herein, it also includes rings containing 1-2 carbon-carbon double bonds. Nonlimiting examples of cycloalkyl include cyclopropyl, cyclobutyl, cyclopentyl, cyclohexyl, cycloheptyl, adamentyl, and the like. The condensed rings may or may not be non-aromatic hydrocarbyl rings provided that the point of attachment is at a cycloalkyl carbon atom. For example, and without limitation, the following is a cycloalkyl group:

[chemical structure]

The terms “alkylene,” “alkenylene” and “arylene” alone or as part of another substituent means a divalent radical derived from an alkyl, alkenyl or aryl group, respectively, as exemplified by —CH₂CH₂CH₂CH₂—. For alkylene, alkenylene and arylene linking groups, no orientation of the linking group is implied.

The term “halo” refers to F, Cl, Br, and I.

The term “nitro” refers to —NO₂.

The term “cyano” refers to —CN.

The term “heteroaryl” refers to a monovalent, aromatic mono-, bi-, or tricyclic ring having 2-14 ring carbon atoms and 1-6 ring heteroatoms selected preferably from N, O, S, and P and oxidized forms of N, S, and P, provided that the ring contains at least 5 ring atoms. Nonlimiting examples of heteroaryl include furan, imidazole, pyridine, quinoline, and the like. The condensed rings may or may not be a heteroatom containing aromatic ring provided that the point of attachment is a heteroaryl atom. For example, and without limitation, the following is a heteroaryl group:

[chemical structure]

The term “heterocyclyl” or heterocycle refers to a non-aromatic, mono-, bi-, or tricyclic ring containing 2-10 ring carbon atoms and 1-6 ring heteroatoms selected preferably from N, O, S, and P and oxidized forms of N, S, and P, provided that the ring contains at least 3 ring atoms. While heterocyclyl preferably refers to saturated ring systems, it also includes ring systems containing 1-3 double bonds, provided that they ring is non-aromatic. Nonlimiting examples of heterocyclyl include, piperidinyl, piperazinyl, pyrrolidinyl, tetrahydrofuranyl, and tetrahydropyranyl. The condensed rings may or may not contain a non-aromatic heteroatom containing ring provided that the point of attachment is a heterocyclyl group. For example, and without limitation, the following is a heterocyclyl group:

[chemical structure]

The term “oxo” refers to a C=0 group, and to a substitution of 2 geminal hydrogen atoms with a C=0 group.

“Geometrical isomer” or “geometrical isomers” refer to compounds that differ in the geometry of one or more olefinic centers. “E” or “(E)” refers to the trans orientation and “Z” or “(Z)” refers to the cis orientation. The polyisoprenyl phosphonate derivative described herein, i.e., the compounds of Formula (I), (II) or (IIA), include one or more olefinic centers, each of which can be in the trans or cis orientation. In certain preferred embodiments, the polyisoprenyl phosphonate derivative described herein, i.e., include one or more olefinic centers, all of which are in the trans orientation.

The term “pharmaceutically acceptable” refers to safe and non-toxic for in vivo, preferably, human administration.

The term “pharmaceutically acceptable salt” refers to a salt that is pharmaceutically acceptable.

The term “salt” refers to an ionic compound formed between an acid and a base. When the compound provided herein contains an acidic functionality, such salts include, without limitation, alkai metal, alkaline earth metal, and ammonium salts. As used herein, ammonium salts include, salts containing protonated nitrogen bases and alkylated nitrogen bases. Exemplary, and non-limiting cations useful in pharmaceutically acceptable salts include Na, K, Rb, Cs, NH₄, Ca, Ba, imidazolium, and ammonium cations based on naturally occurring amino acids. When the compounds utilized herein contain basic functionality, such salts include, without limitation, salts of organic acids, such as caroboxylic acids and sulfonic acids, and mineral acids, such as hydrogen halides, sulfuric acid, phosphoric acid, and the likes. Exemplary and non-limiting anions useful in pharmaceutically acceptable salts include oxalate, maleate, acetate, propionate, succinate, tartrate, chloride, sulfate, bisalfate, mono-, di-, and tribasic phosphate, mesylate, tosylate, and the likes.

The term “neuroprotective” refers to reduced toxicity of neurons as measured in vitro in assays where neurons susceptible to degradation are protected against degradation as compared to control. Neuroprotective effects may also be evaluated in vivo by counting neurons in histology sections.

The term “neuron” or “neurons” refers to all electrically excitable cells that make up the central and peripheral nervous system. The neurons may be cells within the body of an animal or cells cultured outside the body of an animal. The term “neuron” or “neurons” also refers to established or primary tissue culture cell lines that are derived from neural cells from a mammal or tissue culture cell lines that are made to differentiate into neurons. “Neuron” or “neurons” also refers to any of the above types of cells that have also been modified to express a particular protein either extrachromosomally or intrachromosomally. “Neuron” or “neurons” also refers to transformed neurons such as neuroblastoma cells and support cells within the brain such as glia.

The term “protein aggregates” refers to a collection of proteins that may be partially or entirely mis-folded. The protein aggregates may be soluble or insoluble and may be inside the cell or outside the cell in the space between cells. Protein aggregates inside the cell can be intranuclear in which they are inside the nucleus or cytoplasm in which they are in the space outside of the nucleus but still within the cell membrane. The protein aggregates described in this invention are granular protein aggregates.

As used herein, the term “protein aggregate inhibiting amount” refers to an amount of polyisoprenyl phosphonate derivative that inhibits the formation of protein aggregates at least partially or entirely. Unless specified, the inhibition could be directed to protein aggregates inside the cell or outside the cell.

As used herein, the term “intranuclear” or “intranuclearly” refers to the space inside the nuclear compartment of an animal cell.

The term “cytoplasm” refers to the space outside of the nucleus but within the outer cell wall of an animal cell.

As used herein, the term “pathogenic protein aggregate” refers to protein aggregates that are associated with disease conditions. These disease conditions include but are not limited to the death of a cell or the partial or complete loss of the neuronal signaling among two or more cells. Pathogenic protein aggregates can be located inside of a cell, for example, pathogenic intracellular protein aggregates or outside of a cell, for example, pathogenic extracellular protein aggregates.

As used herein, the term “SBMA” refers to the disease spinal and bulbar muscular atrophy. Spinal and bulbar muscular atrophy is a disease caused by pathogenic androgen receptor protein accumulation intranuclearly.

As used herein, the term “ALS” refers to amyotrophic lateral sclerosis disease.

As used herein, the term “AD” refers to Alzheimer's disease.

The term “neurotransmitter” refers to chemicals which transmit signals from a neuron to a target cell. Examples of neurotransmitters include but are not limited to: amino acids such as glutamate, aspartate, serine, γ-aminobutyric acid, and glycine; monoamines such as dopamine, norepinephrine, epinephrine, histamine, serotonin, and melatonin; and other molecules such as acetycholine, adenosine, anadamide, and nitric oxide.

The term “synapse” refers to junctions between neurons. These junctions allow for the passage of chemical signals from one cell to another.

The term “G protein” refers to a family of proteins involved in transmitting chemical signals outside the cell and causing changes inside of the cell. The Rho family of G proteins is small G protein, which are involved in regulating actin cytoskeletal dynamics, cell movement, motility, transcription, cell survival, and cell growth. RHOA, RAC1, and CDC42 are the most studied proteins of the Rho family. Active G proteins are localized to the cellular membrane where they exert their maximal biological effectiveness.

As used herein, the term “treatment” or “treating” means any treatment of a disease or condition in a patient, including one or more of:
preventing or protecting against the disease or condition, that is, causing the clinical symptoms not to develop, for example, in a subject at risk of suffering from such a disease or condition, thereby substantially averting onset of the disease or condition;
inhibiting the disease or condition, that is, arresting or suppressing the development of clinical symptoms; and/or
relieving the disease or condition that is, causing the regression of clinical symptoms.

The term “axon” refers to projections of neurons that conduct signals to other cells through synapses. The term “axon growth” refers to the extension of the axon projection via the growth cone at the tip of the axon.

The term “neural disease” refers to diseases that compromise the cell viability of neurons. Neural diseases in which the etiology of said neural disease comprises formation of protein aggregates which are pathogenic to neurons provided that the protein aggregates are not related to the disease SBMA and are not intranuclear, include but are not limited to ALS, AD, Parkinson's Disease, multiple sclerosis, and prion diseases such as Kuru, Creutzfeltdt-Jakob disease, Fatal familial insomnia, and Gerstmann-Straussler-Scheinker syndrome. These neural diseases are also different from SBMA in that they do not contain polyglutamine repeats. Neural diseases can be recapitulated in vitro in tissue culture cells. For example, AD can be modeled in vitro by adding pre-aggregated β-amyloid peptide to the cells. ALS can be modeled by depleting an ALS disease-related protein, TDP-43. Neural disease can also be modeled in vitro by creating protein aggregates through providing toxic stress to the cell. One way this can be achieved is by mixing dopamine with neurons such as neuroblastoma cells. These neural diseases can also be recapitulated in vivo in mouse models. A transgenic mouse that expresses a mutant Sod1 protein has similar pathology to humans with ALS. Similarly, a transgenic mouse that overexpresses APP has similar pathology to humans with AD.

The term “osteopenia” refers to a disease where osteoclasts dissolve resorb more bone than produced by the bone forming cells, osteoblasts. As used herein, treating osteopenia includes without limitation, modulating osteoclast and/or osteoblast function, and preferably, decreasing osteoclast function in diseases such as osteoporosis, hypercalcemia of malignancy, cancer metastasis to the bone, arthritis, Rheumatoid arthritis, bone loss due to immobilization, Paget's disease of the bone, bone loss due to hyperparathyroidism and other metabolic diseases, bone loss due to treatment with corticosteroids, bone loss due to treatment with aromatase inhibitors, periodontal disease, prosthetic loosening and the like. Methods for modulating and or inhibiting osteoclast function are well known to the skilled artisan, and described, for example, in Boyle et al., EP1717315.

An effective amount of polyisoprenyl phosphonate derivative is the amount of polyisoprenyl phosphonate derivative required to produce a protective effect in vitro or in vivo. In some embodiments the effective amount in vitro is about from 0.1 nM to about 1 mM. In some embodiments the effective amount in vitro is from about 0.1 nM to about 0.5 nM or from about 0.5 nM to about 1.0 nM or from about 1.0 nM to about 5.0 nM or from about 5.0 nM to about 10 nM or from about 10 nM to about 50 nM or from about 50 nM to about 100 nM or from about 100 nM to about 500 nM or from about 500 nM to about 1 mM. In some embodiments, the effective amount for an effect in vivo is about 0.1 mg to about 100 mg, or preferably, from about 1 mg to about 50 mg, or more preferably, from about 1 mg to about 25 mg per kg/day. In some other embodiments, the effective amount in vivo is from about 10 mg/kg/day to about 100 mg/kg/day, about 20 mg/kg/day to about 90 mg/kg/day, about 30 mg/kg/day to about 80 mg/kg/day, about 40 mg/kg/day to about 70 mg/kg/day, or about 50 mg/kg/day to about 60 mg/kg/day. In still some other embodiments, the effective amount in vivo is from about 100 mg/kg/day to about 1000 mg/kg/day.

Routes of administration refers to the method for administering polyisoprenyl phosphonate derivative to a mammal. Administration can be achieved by a variety of methods. These include but are not limited to subcutaneous, intravenous, transdermal, sublingual, or intraperitoneal injection or oral administration.

Unless otherwise indicated, all numbers expressing quantities of ingredients, reaction conditions, and so forth used in the specification and claims are to be understood as being modified in all instances by the term “about.” Accordingly, unless indicated to the contrary, the numerical parameters set forth in the following specification and attached claims are approximations. Each numerical parameter should at least be construed in light of the number of reported significant digits and by applying ordinary rounding techniques.

In certain embodiments, the composition is suitable for the treatment of a neural disease selected from the group consisting of Alzheimer's disease, Parkinson's disease, multiple sclerosis, a prion disease amyotrophic lateral sclerosis, damage to the spinal cord, and neural death during an epileptic seizure.

In further aspects of the invention, a composition is provided comprising the compound of Formula (II) as described herein, or a pharmaceutically acceptable salt thereof, and at least one pharmaceutically acceptable excipient, provided that, when one of R¹⁸ and R¹⁹ is not:

[chemical structure]

and each of R¹⁶ and R¹⁷ is methyl, then R¹⁴ and R¹⁵ together with the carbon atom they are attached to form a C₅-C₇ cycloalkyl optionally substituted with 1-3 C₁-C₆ alkyl groups.

Pharmaceutical compositions can be formulated for different routes of administration. Although compositions suitable for oral delivery will probably be used most frequently, other routes that may be used include intravenous, intraarterial, pulmonary, rectal, nasal, vaginal, lingual, intramuscular, intraperitoneal, intracutaneous, transdermal, intracranial, and subcutaneous routes. Other dosage forms include tablets, capsules, pills, powders, aerosols, suppositories, parenterals, and oral liquids, including suspensions, solutions and emulsions. Sustained release dosage forms may also be used, for example, in a transdermal patch form. All dosage forms may be prepared using methods that are standard in the art (see e.g., Remington's Pharmaceutical Sciences, 16^{th} ed., A. Oslo editor, Easton Pa. 1980).

The compositions are comprised of in general, a polyisoprenyl phosphonate derivative in combination with at least one pharmaceutically acceptable excipient. Acceptable excipients are non-toxic, aid administration, and do not adversely affect the therapeutic benefit of the compound of this invention. Such excipients may be any solid, liquid, semi-solid or, in the case of an aerosol composition, gaseous excipient that is generally available to one of skill in the art. Pharmaceutical compositions in accordance with the invention are prepared by conventional means using methods known in the art.

The compositions disclosed herein may be used in conjunction with any of the vehicles and excipients commonly employed in pharmaceutical preparations, e.g., talc, gum arabic, lactose, starch, magnesium stearate, cocoa butter, aqueous or non-aqueous solvents, oils, paraffin derivatives, glycols, etc. Coloring and flavoring agents may also be added to preparations, particularly to those for oral administration. Solutions can be prepared using water or physiologically compatible organic solvents such as ethanol, 1,2-propylene glycol, polyglycols, dimethylsulfoxide, fatty alcohols, triglycerides, partial esters of glycerin and the like.

Solid pharmaceutical excipients include starch, cellulose, hydroxypropyl cellulose, talc, glucose, lactose, sucrose, gelatin, malt, rice, flour, chalk, silica gel, magnesium stearate, sodium stearate, glycerol monostearate, sodium chloride, dried skim milk and the like. Liquid and semisolid excipients may be selected from glycerol, propylene glycol, water, ethanol and various oils, including those of petroleum, animal, vegetable or synthetic origin, e.g., peanut oil, soybean oil, mineral oil, sesame oil, etc.

The concentration of the excipient is one that can readily be determined to be effective by those skilled in the art, and can vary depending on the particular excipient used. The total concentration of the excipients in the solution can be from about 0.001% to about 90% or from about 0.001% to about 10%.

In certain preferred embodiments of this invention, there is provided a pharmaceutical composition comprising the compound of Formula (I), (II) or (IIA) and α-tocopherol. A related embodiment provides for a pharmaceutical composition comprising the compound of Formula (I), (II) or (IIA), α-tocopherol, and hydroxypropyl cellulose. In another embodiment, there is provided a pharmaceutical composition comprising the compound of Formula (I), (II) or (IIA), α-tocopherol, and gum arabic. In a further embodiment, there is a pharmaceutical composition comprising the compound of Formula (I), (II) or (IIA), and gum arabic. In a related embodiment, there is provided the compound of Formula (I), (II) or (IIA), gum arabic and hydroxypropyl cellulose.

When α-tocopherol is used alone or in combination with other excipients, the concentration by weight can be from about 0.001% to about 1% or from about 0.001% to about 0.005%, or from about 0.005% to about 0.01%, or from about 0.01% to about 0.015%, or from about 0.015% to about 0.03%, or from about 0.03% to about 0.05%, or from about 0.05% to about 0.07%, or from about 0.07% to about 0.1%, or from about 0.1% to about 0.15%, or from about 0.15% to about 0.3%, or from about 0.3% to about 0.5%, or from about 0.5% to about 1% by weight. In some embodiments, the concentration of α-tocopherol is about 0.001% by weight, or alternatively about 0.005%, or about 0.008%, or about 0.01%, or about 0.02%, or about 0.03%, or about 0.04%, or about 0.05% by weight.

When hydroxypropyl cellulose is used alone or in combination with other excipients, the concentration by weight can be from about 0.1% to about 30% or from about 1% to about 20%, or from about 1% to about 5%, or from about 1% to about 10%, or from about 2% to about 4%, or from about 5% to about 10%, or from about 10% to about 15%, or from about 15% to about 20%, or from about 20% to about 25%, or from about 25% to about 30% by weight. In some embodiments, the concentration of hydroxypropyl cellulose is about 1% by weight, or alternatively about 2%, or about 3%, or about 4%, or about 5%, or about 6%, or about 7%, or about 8%, or about 10%, or about 15% by weight.

When gum arabic is used alone or in combination with other excipients, the concentration by weight can be from about 0.5% to about 50% or from about 1% to about 20%, or from about 1% to about 10%, or from about 3% to about 6%, or from about 5% to about 10%, or from about 4% to about 6% by weight. In some embodiments, the concentration of hydroxypropyl cellulose is about 1% by weight, or alternatively about 2%, or about 3%, or about 4%, or about 5%, or about 6%, or about 7%, or about 8%, or about 10%, or about 15% by weight.

The concentration of the polyisoprenyl phosphonate derivative can be from about 1 to about 99% by weight in the pharmaceutical compositions provided herein. In certain embodiments, the concentration of the polyisoprenyl phosphonate derivative in the pharmaceutical composition is about 5% by weight, or alternatively, about 10%, or about 20%, or about 1%, or about 2%, or about 3%, or about 4%, or about 6%, or about 7%, or about 8%, or about 9%, or about 11%, or about 12%, or about 14%, or about 16%, or about 18%, or about 22%, or about 25%, or about 26%, or about 28%, or about 30%, or about 32%, or about 34%, or about 36%, or about 38%, or about 40%, or about 42%, or about 44%, or about 46%, or about 48%, or about 50%, or about 52%, or about 54%, or about 56%, or about 58%, or about 60%, or about 64%, or about 68%, or about 72%, or about 76%, or about 80% by weight.

In one embodiment, this invention provides sustained release formulations such as drug depots or patches comprising an effective amount of the polyisoprenyl phosphonate derivative. In another embodiment, the patch further comprises gum Arabic or hydroxypropyl cellulose separately or in combination, in the presence of alpha-tocopherol. Preferably, the hydroxypropyl cellulose has an average MW of from 10,000 to 100,000. In a more preferred embodiment, the hydroxypropyl cellulose has an average MW of from 5,000 to 50,000. The patch contains, in various embodiments, an amount of the polyisoprenyl phosphonate derivative, which is sufficient to maintain a therapeutically effective amount the polyisoprenyl phosphonate derivative in the plasma for about 12 hours.

Compounds and pharmaceutical compositions of this invention maybe used alone or in combination with other compounds. When administered with another agent, the co-administration can be in any manner in which the pharmacological effects of both are manifest in the patient at the same time. Thus, co-administration does not require that a single pharmaceutical composition, the same dosage form, or even the same route of administration be used for administration of both the compound of this invention and the other agent or that the two agents be administered at precisely the same time. However, co-administration will be accomplished most conveniently by the same dosage form and the same route of administration, at substantially the same time Obviously, such administration most advantageously proceeds by delivering both active ingredients simultaneously in a novel pharmaceutical composition in accordance with the present invention.

In some embodiments, a compound of this invention can be used as an adjunct to conventional drug therapy of the conditions described herein.

### Neural and Neurodegenerative Diseases

In certain embodiments, the methods described herein are suitable for the treatment of a neural disease selected from the group consisting of Alzheimer's disease, Parkinson's disease, multiple sclerosis, a prion disease amyotrophic lateral sclerosis, damage to the spinal cord, and neural death during an epileptic seizure.

Neurodegeneration is often the result of increased age, sporadic mutations, disease, and/or protein aggregation in neural cells. Neurodegenerative diseases are often characterized by a progressive neurodegeneration of tissues of the nervous system and a loss of functionality of the neurons themselves. One commonality seen in most neurodegenerative diseases is the accumulation of protein aggregates intracellularly or in the extracellular space between neurons.

Protein aggregation is facilitated by partial unfolding or denaturation of cellular proteins. This may be due to mutations in the sequence of the DNA, transcriptional misincorporation, modifications to the RNA, and modifications or oxidative stress to the protein. There is an increasing amount of evidence to suggest that protein aggregates contribute to disease progression. In one study, aggregates of two non-disease proteins were formed in vitro and added to the medium of cultured cells. Addition of granular-structured, protein aggregates significantly reduced the cell viability of both the fibroblastic cell line (NIH-3T3) and neural cell line (PC 12). However, addition of more organized fibrillar protein aggregates did not compromise the cell viability. (Bucciantini et al. (2002) Nature 14:507-510.)

Protein aggregates can be extracellular (i.e. in the space between neural cells), intracellular such as intranuclear (i.e. in the nucleus of the cell), or in the cytoplasm. Extracellular and/or cytoplasm protein aggregates are a pathological characteristic of Alzheimer's disease (AD) and amyotrophic lateral sclerosis (ALS). AD is a progressive brain disease that destroys memory and cognitive function. AD has been linked to the aggregation of the β-amyloid peptide. The β-amyloid peptide is derived from the amyloid precursor protein (APP) that has been processed by two aspartyl proteases called β and γ secretases. Similar to AD, ALS is also a progressive neurodegenerative disease and is characterized by loss of functionality of motor neurons. The progressive degeneration of motor neurons results in loss of ability of the brain to initiate and control muscle movement. ALS is a devastating disease, in which the last stage is complete paralysis. The complete molecular mechanism of disease progression in ALS is not yet clear, but mutations in the Cu/Zn superoxide dismutase (Sod) gene, Sod1, have been linked to the degeneration of motor neurons. The disease symptoms of ALS and AD may differ, but the presence of cytotoxic aggregate proteins in both diseases suggests a common mechanism in pathogenicity. (Ross & Poirier. (2004) Nat. Med. pp S10-S17; Irvine et al. (2008) Mol. Med. 14(7-8):451-464; Wang et al. (2008) PLoS One Vol. 6, Issue 7, pp 1508-1526. Iguchi et al. (2009) J. Bio Chem. Vol. 284 no. 33 pp. 22059-22066; Bruijn (1998) Science Vol. 281: 1851-1854.)

Recently, it was also found that depletion of the TDP-43 protein (TAR DNA binding protein or TARDBP) in Neuro-2a cells causes protein aggregation similar to what is observed in ALS. In fact, point mutations in TARDBP have been linked to familial and sporadic ALS. TDP-43 depletion by TARDBP siRNA in Neuro-2a cells also causes inhibition of the biological activity of the Rho family of small G proteins. Therefore, TDP-43 and Rho family proteins negatively affect protein aggregate formation in neural cells. The Rho family proteins are responsible for regulating cell movement, cell survival, cell growth, transcription, and motility of cells (Iguchi et al. (2009) J. Bio Chem. Vol. 284 no. 33 pp. 22059-22066). Therapies that prevent reduction in the amount and/or activity of TDP-43 or Rho family proteins may have a neuroprotective effect on cells.

This invention provides methods for using the polyisoprenyl phosphonate derivative, or an isomer thereof for inhibiting neural death and increasing neural activity. For example, and without limitation, the invention provides methods for impeding the progression of neurodegenerative diseases or injury using the polyisoprenyl phosphonate derivative. The pharmaceutical compositions and/or compounds described above are useful in the methods described herein.

In one aspect, there are methods for increasing the axon growth of neurons by contacting said neurons with an effective amount of the polyisoprenyl phosphonate derivative. Neural diseases can result in an impairment of signaling between neurons. This can in part be due to a reduction in the growth of axonal projections. Contacting neurons with the polyisoprenyl phosphonate derivative enhances axonal growth. It is contemplated that the polyisoprenyl phosphonate derivative will restore axonal grown in neurons afflicted with a neural disease. In a related embodiment, the pre-contacted neurons exhibit a reduction in the axon growth ability.

Methods include the use of the polyisoprenyl phosphonate derivative. One embodiment of this invention is directed to a method for inhibiting the cell death of neurons susceptible to neuronal cell death, which method comprises contacting said neurons with an effective amount of the polyisoprenyl phosphonate derivative. Neurons susceptible to neuronal cell death include those that have the characteristics of a neurodegenerative disease and/or those that have undergone injury or toxic stress. One method of creating toxic stress to a cell is by mixing dopamine with neurons such as neuroblastoma cells. Another source of toxic stress is oxidative stress. Oxidative stress can occur from neuronal disease or injury. It is contemplated that contacting neurons with the polyisoprenyl phosphonate derivative will inhibit their death as measured by a MTT assay or other techniques commonly known to one skilled in the art.

In another aspect, there are methods for increasing the neurite growth of neurons by contacting said neurons with an effective amount of the polyisoprenyl phosphonate derivative. The term “neurite” refers to both axons and dendrites. Neural diseases can result in an impairment of signaling between neurons. This can in part be due to a reduction in the growth of axonal and/or dendritic projections. It is contemplated that contacting neurons with the polyisoprenyl phosphonate derivative will enhance neurite growth. It is further contemplated that the polyisoprenyl phosphonate derivative will restore neurite grown in neurons afflicted with a neural disease. In a related embodiment, the pre-contacted neurons exhibit a reduction in the neurite growth ability.

One embodiment of this invention is directed to a method for increasing the expression and/or release of one or more neurotransmitters from a neuron by contacting said neurons with an effective amount of the polyisoprenyl phosphonate derivative. It is contemplated that contacting neurons with an effective amount of the polyisoprenyl phosphonate derivative will increase the expression level of one or more neurotransmitters. It is also contemplated that contacting neurons with the polyisoprenyl phosphonate derivative will increase the release of one or more neurotransmitters from neurons. The release of one or more neurotransmitters refers to the exocytotic process by which secretory vesicles containing one or more neurotransmitters are fused to cell membrane, which directs the neurotransmitters out of the neuron. It is contemplated that the increase in the expression and/or release of neurotransmitters will lead to enhanced signaling in neurons, in which levels of expression or release of neurotransmitters are otherwise reduced due to the disease. The increase in their expression and release can be measured by molecular techniques commonly known to one skilled in the art.

One embodiment of this invention is directed to a method for inducing synapse formation of a neuron by contacting said neurons with an effective amount of the polyisoprenyl phosphonate derivative. A synapse is a junction between two neurons. Synapses are essential to neural function and permit transmission of signals from one neuron to the next. Thus, an increase in the neural synapses will lead to an increase in the signaling between two or more neurons. It is contemplated that contacting the neurons with an effective amount of the polyisoprenyl phosphonate derivative will increase synapse formation in neurons that otherwise experience reduced synapse formation as a result of neural disease.

Another embodiment of this invention is directed to a method for increasing electrical excitability of a neuron by contacting said neurons with an effective amount of the polyisoprenyl phosphonate derivative. Electrical excitation is one mode of communication among two or more neurons. It is contemplated that contacting neurons with an effective amount of the polyisoprenyl phosphonate derivative will increase the electrical excitability of neurons in which electrical excitability and other modes of neural communication are otherwise impaired due to neural disease. Electrical excitability can be measured by electrophysiological methods commonly known to one skilled in the art.

In each of the three previous paragraphs above, the administration of the polyisoprenyl phosphonate derivative enhances communication between neurons and accordingly provides for a method of inhibiting the loss of cognitive abilities in a mammal that is at risk of dementia or suffering from incipient or partial dementia while retaining some cognitive skills. Incipient or partial dementia in a mammal is one in which the mammal still exhibits some cognitive skills, but the skills are being lost and/or diminished over time. Method comprises administering an effective amount of the polyisoprenyl phosphonate derivative to said patient.

In another embodiment, this invention is directed to a method for inhibiting the death of neurons due to formation of or further formation of pathogenic protein aggregates between, outside or inside neurons, wherein said method comprises contacting said neurons at risk of developing said pathogenic protein aggregates with an amount of the polyisoprenyl phosphonate derivative inhibitory to protein aggregate formation, provided that said pathogenic protein aggregates are not related to SBMA. In one embodiment of this invention, the pathogenic protein aggregates form between or outside of the neurons. In another embodiment of this invention, the pathogenic protein aggregates form inside said neurons. In one embodiment of this invention, the pathogenic protein aggregates are a result of toxic stress to the cell. One method of creating toxic stress to a cell is by mixing dopamine with neurons such as neuroblastoma cells. It is contemplated that contacting neurons with the polyisoprenyl phosphonate derivative will inhibit their death as measured by a MTT assay or other techniques commonly known to one skilled in the art.

Another embodiment of the invention is directed to a method for protecting neurons from pathogenic extracellular protein aggregates which method comprises contacting said neurons and/or said pathogenic protein aggregates with an amount of the polyisoprenyl phosphonate derivative that inhibits further pathogenic protein aggregation. In one embodiment of this invention, contacting said neurons and/or said pathogenic protein aggregates with an effective amount of the polyisoprenyl phosphonate derivative alters the pathogenic protein aggregates into a non-pathogenic form. Without being limited to any theory, it is contemplated that contacting the neurons and/or the pathogenic protein aggregates with the polyisoprenyl phosphonate derivative will solubilize at least a portion of the pathogenic protein aggregates residing between, outside, or inside of the cells. It is further contemplated that contacting the neurons and/or the pathogenic protein aggregates with the polyisoprenyl phosphonate derivative will alter the pathogenic protein aggregates in such a way that they are non-pathogenic. A non-pathogenic form of the protein aggregate is one that does not contribute to the death or loss of functionality of the neuron. There are many assays known to one skilled in the art for measuring the protection of neurons either in cell culture or in a mammal. One example is a measure of increased cell viability by a MTT assay. Another example is by immunostaining neurons in vitro or in vivo for cell death-indicating molecules such as, for example, caspases or propidium iodide.

In yet another embodiment of the invention is directed to a method for protecting neurons from pathogenic intracellular protein aggregates which method comprises contacting said neurons with an amount of the polyisoprenyl phosphonate derivative which will inhibit further pathogenic protein aggregation provided that said protein aggregation is not related to SBMA. This method is not intended to inhibit or reduce, negative effects of neural diseases in which the pathogenic protein aggregates are intranuclear or diseases in which the protein aggregation is related to SBMA. SBMA is a disease caused by pathogenic androgen receptor protein accumulation. It is distinct from the neural diseases mentioned in this application since the pathogenic protein aggregates of SBMA contain polyglutamines and are formed intranuclearly. It is also distinct from the neural diseases described in this application because the protein aggregates are formed from androgen receptor protein accumulation. It is contemplated that contacting neurons with an effective amount of the polyisoprenyl phosphonate derivative will alter the pathogenic protein aggregate into a non-pathogenic form.

One embodiment of the invention is directed to a method of modulating the activity of G proteins in neurons which method comprises contacting said neurons with an effective amount of the polyisoprenyl phosphonate derivative. It is contemplated that contacting neurons with the polyisoprenyl phosphonate derivative will alter the sub-cellular localization, thus changing the activities of the G protein in the cell. In one embodiment of the invention, contacting neurons with the polyisoprenyl phosphonate derivative will enhance the activity of G proteins in neurons. It is contemplated that contacting the polyisoprenyl phosphonate derivative with neurons will increase the expression level of G proteins. It is also contemplated that contacting the polyisoprenyl phosphonate derivative with neurons will enhance the activity of G proteins by changing their sub-cellular localization to the cell membranes where they must be to exert their biological activities.

One embodiment of the invention is directed to a method of modulating or enhancing the activity of G proteins in neurons at risk of death which method comprises contacting said neurons with an effective amount of the polyisoprenyl phosphonate derivative. Neurons may be at risk of death as a result of genetic changes related to ALS. One such genetic mutation is a depletion of the TDP-43 protein. It is contemplated that neurons with depleted TDP-43 or other genetic mutations associated with ALS will have an increase or change in the activity of G proteins after being contacted with the polyisoprenyl phosphonate derivative. It is further contemplated that the polyisoprenyl phosphonate derivative will result in an increase in the activity of G proteins in these cells by changing their sub-cellular localization to the cell membranes where they must be to exert their biological activities.

Another embodiment of the invention is directed to a method for inhibiting the neurotoxicity of β-amyloid peptide by contacting the β-amyloid peptide with an effective amount of the polyisoprenyl phosphonate derivative. In one embodiment of the invention the β-amyloid peptide is between or outside of neurons. In yet another embodiment of the invention, the β-amyloid peptide is part of the β-amyloid plaque. It is contemplated that contacting neurons with the polyisoprenyl phosphonate derivative will result in solubilizing at least a portion of the β-amyloid peptide, thus decreasing its neurotoxicity. It is further contemplated that the polyisoprenyl phosphonate derivative will decrease the toxicity of the β-amyloid peptide by altering it in such a way that it is no longer toxic to the cell. It is also believed that the polyisoprenyl phosphonate derivative will induce the expression of heat shock proteins (HSPs) in the neurons. It is also contemplated that HSPs will be induced in support cells such as glial cells. The induced heat shock proteins in the neurons or glial cells may be transmitted extracellularly and act to dissolve extracellular protein aggregates. Cell viability can be measured by standard assays known to those skilled in the art. One such example of an assay to measure cell viability is a MTT assay. Another example is a MTS assay. The modulation of protein aggregation can be visualized by immunostaining or histological staining techniques commonly known to one skilled in the art.

One embodiment of the invention is directed to a method for inhibiting neural death and increasing neural activity in a mammal suffering from neural diseases, wherein the etiology of said neural diseases comprises formation of protein aggregates which are pathogenic to neurons, and which method comprises administering to said mammal an amount of the polyisoprenyl phosphonate derivative which will inhibit further pathogenic protein aggregation. This method is not intended to inhibit neural death and increase neural activity in neural diseases in which the pathogenic protein aggregates are intranuclear or diseases in which the protein aggregation is related to SBMA.

Neural diseases such as AD and ALS disease have the common characteristic of protein aggregates either inside neural cells in cytoplasm or in the extracellular space between two or more neural cells. This invention relates to a method for using the polyisoprenyl phosphonate derivative to inhibit the formation of the protein aggregates or alter the pathogenic protein aggregates into a non-pathogenic form. It is contemplated that this will attenuate some of the symptoms associated with these neural diseases.

In one embodiment the mammal is a human afflicted with a neural disease. In one embodiment of this invention, the negative effect of the neural disease being inhibited or reduced is ALS. ALS is characterized by a loss of functionality of motor neurons. This results in the inability to control muscle movements. ALS is a neurodegenerative disease that does not typically show intranuclear protein aggregates. It is contemplated that the polyisoprenyl phosphonate derivative will prevent or inhibit the formation of extracellular or intracellular protein aggregates that are cytoplasm, not intranuclear and not related to SBMA. It is also contemplated that the polyisoprenyl phosphonate derivative will alter the pathogenic protein aggregates into a form that is non-pathogenic. Methods for diagnosing ALS are commonly known to those skilled in the art. Additionally, there are numerous patents that describe methods for diagnosing ALS. These include U.S. Pat. No. 5,851,783 and U.S. Pat. No. 7,356,521 both of which are incorporated herein by reference in their entirety.

In one embodiment of the invention the negative effect of the neural disease being inhibited or reduced is AD. AD is a neurodegenerative disease that does not typically show intranuclear protein aggregates. It is contemplated that the polyisoprenyl phosphonate derivative will prevent or inhibit the formation of extracellular or intracellular protein aggregates. It is also contemplated that the polyisoprenyl phosphonate derivative will alter the pathogenic protein aggregates into a form that is non-pathogenic. Methods for diagnosing AD are commonly known to those skilled in the art. Additionally, there are numerous patents that describe methods for diagnosing AD. These include U.S. Pat. No. 6,130,048 and U.S. Pat. No. 6,391,553 both of which are incorporated herein by reference in their entirety.

In another embodiment, the mammal is a laboratory research mammal such as a mouse. In one embodiment of this invention, the neural disease is ALS. One such mouse model for ALS is a transgenic mouse with a Sod1 mutant gene. It is contemplated that the polyisoprenyl phosphonate derivative will enhance the motor skills and body weights when administered to a mouse with a mutant Sod1 gene. It is further contemplated that administering a polyisoprenyl phosphonate derivative to this mouse will increase the survival rate of Sod1 mutant mice. Motor skills can be measured by standard techniques known to one skilled in the art. Sod1 mutant mice provide an accepted mouse model for modeling ALS in humans. Accordingly, method aspects of this disclosure relate to a method for prolonging the survival or reducing mortality of a subject with ALS, comprising administering a therapeutically effective amount of the polyisoprenyl phosphonate derivative.

In yet another embodiment of this invention, the neural disease is AD. One example of a transgenic mouse model for AD is a mouse that overexpresses the APP (Amyloid beta Precursor Protein). It is contemplated that administering the polyisoprenyl phosphonate derivative to a transgenic AD mouse will improve the learning and memory skills of said mouse. It is further contemplated that the polyisoprenyl phosphonate derivative will decrease the amount and/or size of β-amyloid peptide and/or plaque found inside, between, or outside of neurons. The β-amyloid peptide or plaque can be visualized in histology sections by immunostaining or other staining techniques.

In one embodiment of the invention administering the polyisoprenyl phosphonate derivative to a mammal alters the pathogenic protein aggregate present into a non-pathogenic form. In another embodiment of the invention, administering the polyisoprenyl phosphonate derivative to a mammal will prevent pathogenic protein aggregates from forming.

Another aspect of this invention relates to a method for reducing seizures in a mammal in need thereof, which method comprises administering a therapeutically effective amount of the polyisoprenyl phosphonate derivative, thereby reducing seizures. The reduction of seizures refers to reducing the occurrence and/or severity of seizures. In one embodiment, the seizure is epileptic seizure. In another embodiment, the methods of this invention prevent neural death during epileptic seizures. The severity of the seizure can be measured by one skilled in the art.

In certain aspects, the methods described herein relate to administering the polyisoprenyl phosphonate derivative or the compositions of the polyisoprenyl phosphonate derivative in vitro. In other aspects the administration is in vivo. In yet other aspects, the in vivo administration is to a mammal. Mammals include but are not limited to humans and common laboratory research animals such as, for example, mice, rats, dogs, pigs, cats, and rabbits.

### Assaying Compounds

There are multiple osteoclast culture systems or methods and bone formation assays that can be used successfully to screen potential an anti-resorptive compound provided or utilized in this invention. See, e.g., U.S. Pat. No. 6,080,779.

One osteoclast culture for use in screening is a neonatal mouse calvaria assay. Briefly, four days after birth, the front and parietal bones of neonatal mouse pups (e.g., ICR Swiss white mice) are removed by microdissection and split along the sagittal suture. The bones are then incubated in a specified medium, wherein the medium contains either test or control compounds. Following the incubation, the bones are removed from the media, and fixed in 10% buffered formalin, decalcified in EDTA, processed through graded alcohols, and embedded in paraffin wax. Sections of the calvaria are prepared and assessed using histomorphometric analysis of bone formation and bone resorption. Bone changes are measured on sections. Osteoblasts and osteoclasts are identified by their distinctive morphology.

In addition to this assay, the effect of compounds on murine calvarial bone growth can also be tested in vivo. In one such example of this screening assay, young male mice (e.g., ICR Swiss white mice), aged 4-6 weeks are employed, using 4-5 mice per group. Briefly, the test compound or the appropriate control is injected into subcutaneous tissue over the right calvaria of normal mice. The mice are sacrificed (after allowing for bone growth or loss to occur, e.g. on day 14), and net bone growth is measured by histomorphometric means. Bone samples are cleaned from adjacent tissues and fixed in 10% buffered formalin, decalcified, processed through graded alcohols, and embedded in paraffin wax. Sections of the calvaria are prepared, and representative sections are selected for histomorphometric assessment of the effects of bone formation and bone resorption. In one embodiment, sections are measured by using a camera lucida attachment to trace directly the microscopic image onto a digitizing plate. Bone changes are measured on sections over adjacent 1×1 mm fields on both the injected and noninjected sides of calvaria. New bone may be identified by those skilled in the art by its characteristic tinctorial features, and osteoclasts and osteoblasts may be identified by their distinctive morphology or other suitable marker recognized by the skilled artisan. Histomorphometry software (OsteoMeasure, Osteometrix, Inc., Atlanta) can be used to process digitized input to determine cell counts and measure areas or perimeters.

Additional exemplary in vivo assays include dosing assays in intact animals, including dosing assays in acute ovariectomized (OVX) animals and assays in chronic OVX animals. Prototypical dosing in intact animals may be accomplished by subcutaneous, intraperitoneal or oral administration, and may be performed by injection, sustained release or other delivery techniques. The time period for administration of test compound may vary (for instance, 14 days, 28 days, as well as 35 days or longer may be appropriate).

As an example, in vivo oral or subcutaneous dosing assay may be performed as described: In a typical study, 70 three-month-old female Sprague-Dawley rats are weight-matched and divided into treatment groups, with at least several animals in each group. This includes a baseline control group of animals sacrificed at the initiation of the study; a control group administered vehicle only; a PBS or saline-treated control group; and a positive group administered a compound known to enhance net bone formation. Three dosage levels of the test compound are administered to the remaining groups. Test compound, saline, and vehicle are administered (e.g. once per day) for a number of days (for instance at least 14 days, 28 days, or 35 days—wherein an effect is expected in the positive group). All animals are injected with calcein nine days and two days before sacrifice (to ensure proper labeling of newly formed bone). Weekly body weights are determined. At the end of the period of compound administration, the animals are weighed and bled by orbital or cardiac puncture. Serum calcium, phosphate, osteocalcin, and CBCs are determined. Both leg bones (femur and tibia) and lumbar vertebrae are removed, cleaned of adhering soft tissue, and stored in 70% ethanol or 10% formalin for evaluation, for instance as performed by peripheral quantitative computed tomography (pQCT; Ferretti, J, Bone, 17: 353S-364S, 1995), dual energy X-ray absorptiometry (DEXA; Laval-Jeantet A. et al., Calcif Tissue Intl, 56:14-18, 1995, and Casez J. et al., Bone and Mineral, 26:61-68, 1994) and/or histomorphometry. The effect of test compounds on bone remodeling or net bone formation, including bone loss and osteoclast function can thus be evaluated.

Test compounds can also be assayed in acute ovariectomized animals. Such assays may also include an estrogen-treated group as a control. An example of the test in these animals is briefly described: In a typical study, 80 three-month-old female Sprague-Dawley rats are weight-matched and divided into treatment groups, with at least several animals in each group. This includes a baseline control group of animals sacrificed at the initiation of the study; three control groups (sham OVX and vehicle only, OVX and vehicle only, and OVX and PBS only); and a control OVX group that is administered a compound known to block or reduce bone resorption or enhance bone formation (including an anti-resorptive or anabolic compound). Different dosage levels of the test compound are administered to remaining groups of OVX animals.

Since ovariectomy induces hyperphagia, all OVX animals are pair-fed with sham OVX animals throughout the study. Test compound, positive control compound, PBS or saline or vehicle alone is administered orally or subcutaneously (e.g., once per day) for the treatment period. As an alternative, test compounds can be formulated in implantable pellets that are implanted, or may be administered orally, such as by gastric gavage. All animals are injected with calcein nine days and two days before sacrifice. Weekly body weights are determined. At the end of the treatment cycle, the animals blood and tissues are processed as described above.

Test compounds may also be assayed in chronic OVX animals. Briefly, six month old female, Sprague-Dawley rats are subjected to sham surgery (sham OVX), or ovariectomy (OVX) at the beginning of the experiment, and animals are sacrificed at the same time to serve as baseline controls. Body weights are monitored weekly. After approximately six weeks or more of bone depletion, sham OVX and OVX rats are randomly selected for sacrifice as depletion period controls. Of the remaining animals, 10 sham OVX and 10 OVX rats are used as placebo-treated controls. The remaining animals are treated with 3 to 5 doses of test compound for a period of 35 days. As a positive control, a group of OVX rats can be treated with a known anabolic or anti-resorptive agent in this model, such as bisphosphonate, a calcitonin, a calcitriol, an estrogen, selective estrogen receptor modulators (SERM's) and a calcium source, a supplemental bone formation agent parathyroid hormone (PTH) or its derivative (Kimmel et al., Endocrinology, 132: 1577-1584, 1993), PTHRP, a bone morphogenetic protein, osteogenin, NaF, PGE2 agonists, a statin, and a RANK ligand (RANKL), including an osteogenic form of RANKL such as GST-RANKL or other oligomerized form of RANKL. At the end of the experiment, the animals are sacrificed and femurs, tibiae, and lumbar vertebral to 4 are excised and collected. The proximal left and right tibiae are used for pQCT measurements, cancellous bone mineral density (BMD), and histology, while the midshaft of each tibiae is subjected to cortical BMD or histology. The femurs are prepared for pQCT scanning of the midshaft prior to biomechanical testing. With respect to lumbar vertebrae (LV), LV2 are processed for BMD (pQCT may also be performed), LV3 are prepared for undecalcified bone histology, and LV4 are processed for mechanical testing.

In addition, osteoclast cultures, containing macrophages, osteoclast precursors and osteoclasts, can be generated from bone marrow precursors, particularly from bone marrow macrophages and utilized in assessment of compounds for osteoclast modulating activity. Bone marrow macrophages are cultured in 48- or 96-well cell culture dishes in the presence of M-CSF (10 ng/ml), RANKL (100 ng/ml), with or without addition of compound(s) or control(s), and medium changed (e.g. on day 3). Osteoclast-like cells are characterized by staining for tartrate-resistant acid phosphatase (TRAP) activity. In assessing bone resorption, for instance using a pit assay, osteoclasts are generated on whale dentin slices from bone marrow macrophages. After three days of culture to generate osteoclasts, compound(s) or control(s) are added to the culture for two days. At the end of the experiment, cells are TRAP stained and photographed to document cell number. Cells are then removed from the dentin slices with 0.5M ammonium hydroxide and mechanical agitation. Maximum resorption lacunae depth is measured using a confocal microscope (Microradiance, Bio-Rad Laboratories, Hercules, Calif.). For evaluation of pit number and resorbed area, dentin slices are stained with Coumassie brilliant blue and analyzed with light microscopy using Osteomeasure software (Osteometrics, Decatur, Ga.) for quantitation.

In a further method, osteoclast modulating ability of GGA and derivatives can be tested in an in vitro assay utilizing osteoclasts, osteoclast precursor cells or osteoclast-like cells. General protocols for treatment of osteoclasts with a compound are well established and known in the art. For instance, bone marrow macrophages may be utilized to generate osteoclasts in vitro as described herein. It is to be noted that the conditions used will vary according to the cell lines and compound used, their respective amounts, and additional factors such as plating conditions and media composition. Such adjustments are readily determined by one skilled in this art.

### Synthesis of the Polyisoprenyl Phosphonate Derivatives

The compounds can be synthesized following methods and/or modifications thereof well known in the art. See, for example, Fieser, Mary ed. Fieser and Fieser's Reagents for Organic Synthesis. Wiley, NY; Smith and March, March's Advanced Organic Chemistry, 6^{th} Edition, John Wiley & Sons, Inc., New York, 2011; Larock, Comprehensive Organic Transformations, 2^{nd} edition, VCH Publishers, Inc., New York, 1999; T. W. Greene and P. G. M. Wuts, Protecting Groups in Organic Synthesis, 4^{th} edition, John Wiley & Sons, 2006, and the likes. The starting materials are commercially available from Sigma Aldrich Company (St. Louis, Mo.) and such other commercial suppliers. It will also be apparent to the skilled artisan that the methods further employ routine steps of separation or purification to isolate the compounds, following methods such as chromatography, distillation, or crystallization.

The reactions are preferably carried out in a suitable inert solvent that will be apparent to the skilled artisan upon reading this disclosure, for a sufficient period of time to ensure substantial completion of the reaction as observed by thin layer chromatography, ¹H-NMR, etc. If needed to speed up the reaction, the reaction mixture can be heated, as is well known to the skilled artisan. The final and the intermediate compounds are purified, if necessary, by various art known methods such as crystallization, precipitation, column chromatography, and the likes, as will be apparent to the skilled artisan upon reading this disclosure.

Specific non-limiting examples of bisphosphonate conjugates provided herein and their methods of synthesis are described below. Other such conjugates can be synthesized following adaptation of art known methods and those described herein.

[chemical structure]

[chemical structure]

Other such compounds having the:

[chemical structure]

moiety, instead of the polyprenyl moiety shown above, wherein the variables are defined as herein are also provided herein.

### Pharmaceutical Compositions

In further aspects of the invention, a composition for treatment of osteopenia and related conditions or for reducing the negative effects of osteopenia, and related conditions is provided, the composition comprising compounds provided herein and/or utilized herein, or a pharmaceutically acceptable salt thereof, and at least one pharmaceutically acceptable excipient.

Pharmaceutical compositions can be formulated for different routes of administration. Although compositions suitable for oral delivery will probably be used most frequently, other routes that may be used include intravenous, intraarterial, pulmonary, rectal, nasal, vaginal, lingual, intramuscular, intraperitoneal, intracutaneous, transdermal, intracranial, and subcutaneous routes. Other dosage forms include tablets, capsules, pills, powders, aerosols, suppositories, parenterals, and oral liquids, including suspensions, solutions and emulsions. Sustained release dosage forms may also be used, for example, in a transdermal patch form. All dosage forms may be prepared using methods that are standard in the art (see e.g., Remington's Pharmaceutical Sciences, 16^{th} ed., A. Oslo editor, Easton Pa. 1980).

The compositions are comprised of in general, compounds provided herein and/or utilized herein in combination with at least one pharmaceutically acceptable excipient. Acceptable excipients are non-toxic, aid administration, and do not adversely affect the therapeutic benefit of the compound of this invention. Such excipients may be any solid, liquid, semi-solid or, in the case of an aerosol composition, gaseous excipient that is generally available to one of skill in the art. Pharmaceutical compositions in accordance with the invention are prepared by conventional means using methods known in the art.

The compositions disclosed herein may be used in conjunction with any of the vehicles and excipients commonly employed in pharmaceutical preparations, e.g., talc, gum arabic, lactose, starch, magnesium stearate, cocoa butter, aqueous or non-aqueous solvents, oils, paraffin derivatives, glycols, etc. Coloring and flavoring agents may also be added to preparations, particularly to those for oral administration. Solutions can be prepared using water or physiologically compatible organic solvents such as ethanol, 1,2-propylene glycol, polyglycols, dimethylsulfoxide, fatty alcohols, triglycerides, partial esters of glycerin and the like.

Solid pharmaceutical excipients include starch, cellulose, hydroxypropyl cellulose, talc, glucose, lactose, sucrose, gelatin, malt, rice, flour, chalk, silica gel, magnesium stearate, sodium stearate, glycerol monostearate, sodium chloride, dried skim milk and the like. Liquid and semisolid excipients may be selected from glycerol, propylene glycol, water, ethanol and various oils, including those of petroleum, animal, vegetable or synthetic origin, e.g., peanut oil, soybean oil, mineral oil, sesame oil, etc.

The concentration of the excipient is one that can readily be determined to be effective by those skilled in the art, and can vary depending on the particular excipient used. The total concentration of the excipients in the solution can be from about 0.001% to about 90% or from about 0.001% to about 10%.

In certain preferred embodiments of this invention, there is provided a pharmaceutical composition comprising compounds provided herein and/or utilized herein and α-tocopherol. A related embodiment provides for a pharmaceutical composition comprising compounds provided herein and/or utilized herein, α-tocopherol, and hydroxypropyl cellulose. In another embodiment, there is provided a pharmaceutical composition comprising compounds provided herein and/or utilized herein, α-tocopherol, and gum arabic. In a further embodiment, there is a pharmaceutical composition comprising compounds provided herein and/or utilized herein, and gum arabic. In a related embodiment, there is provided compounds provided herein and/or utilized herein, gum arabic and hydroxypropyl cellulose.

When α-tocopherol is used alone or in combination with other excipients, the concentration by weight can be from about 0.001% to about 1% or from about 0.001% to about 0.005%, or from about 0.005% to about 0.01%, or from about 0.01% to about 0.015%, or from about 0.015% to about 0.03%, or from about 0.03% to about 0.05%, or from about 0.05% to about 0.07%, or from about 0.07% to about 0.1%, or from about 0.1% to about 0.15%, or from about 0.15% to about 0.3%, or from about 0.3% to about 0.5%, or from about 0.5% to about 1% by weight. In some embodiments, the concentration of α-tocopherol is about 0.001% by weight, or alternatively about 0.005%, or about 0.008%, or about 0.01%, or about 0.02%, or about 0.03%, or about 0.04%, or about 0.05% by weight.

When hydroxypropyl cellulose is used alone or in combination with other excipients, the concentration by weight can be from about 0.1% to about 30% or from about 1% to about 20%, or from about 1% to about 5%, or from about 1% to about 10%, or from about 2% to about 4%, or from about 5% to about 10%, or from about 10% to about 15%, or from about 15% to about 20%, or from about 20% to about 25%, or from about 25% to about 30% by weight. In some embodiments, the concentration of hydroxypropyl cellulose is about 1% by weight, or alternatively about 2%, or about 3%, or about 4%, or about 5%, or about 6%, or about 7%, or about 8%, or about 10%, or about 15% by weight.

When gum arabic is used alone or in combination with other excipients, the concentration by weight can be from about 0.5% to about 50% or from about 1% to about 20%, or from about 1% to about 10%, or from about 3% to about 6%, or from about 5% to about 10%, or from about 4% to about 6% by weight. In some embodiments, the concentration of hydroxypropyl cellulose is about 1% by weight, or alternatively about 2%, or about 3%, or about 4%, or about 5%, or about 6%, or about 7%, or about 8%, or about 10%, or about 15% by weight.

The concentration of compounds provided herein and/or utilized herein can be from about 1 to about 99% by weight in the pharmaceutical compositions provided herein. In certain embodiments, the concentration of compounds provided herein and/or utilized herein in the pharmaceutical composition is about 5% by weight, or alternatively, about 10%, or about 20%, or about 1%, or about 2%, or about 3%, or about 4%, or about 6%, or about 7%, or about 8%, or about 9%, or about 11%, or about 12%, or about 14%, or about 16%, or about 18%, or about 22%, or about 25%, or about 26%, or about 28%, or about 30%, or about 32%, or about 34%, or about 36%, or about 38%, or about 40%, or about 42%, or about 44%, or about 46%, or about 48%, or about 50%, or about 52%, or about 54%, or about 56%, or about 58%, or about 60%, or about 64%, or about 68%, or about 72%, or about 76%, or about 80% by weight.

In one embodiment, this invention provides sustained release formulations such as drug depots or patches comprising an effective amount of compounds provided herein and/or utilized herein. In another embodiment, the patch further comprises gum Arabic or hydroxypropyl cellulose separately or in combination, in the presence of alpha-tocopherol. Preferably, the hydroxypropyl cellulose has an average MW of from 10,000 to 100,000. In a more preferred embodiment, the hydroxypropyl cellulose has an average MW of from 5,000 to 50,000. The patch contains, in various embodiments, an amount of the compounds provided herein and/or utilized herein, which is sufficient to maintain a therapeutically effective amount of compounds provided herein and/or utilized herein in the plasma for about 12 hours.

Compounds and pharmaceutical compositions of this invention maybe used alone or in combination with other compounds. When administered with another agent, the co-administration can be in any manner in which the pharmacological effects of both are manifest in the patient at the same time. Thus, co-administration does not require that a single pharmaceutical composition, the same dosage form, or even the same route of administration be used for administration of both the compound of this invention and the other agent or that the two agents be administered at precisely the same time. However, co-administration will be accomplished most conveniently by the same dosage form and the same route of administration, at substantially the same time. Obviously, such administration most advantageously proceeds by delivering both active ingredients simultaneously in a novel pharmaceutical composition in accordance with the present invention.

In some embodiments, a compound of this invention can be used as an adjunct to conventional drug therapy of the conditions described herein.

### Utility

It is contemplated that the polyisoprenyl phosphonate derivatives and/or compositions containing the same can be used to inhibit neural death and increase neural activity in a mammal suffering from a neural disease, wherein the etiology of said neural disease comprises formation of protein aggregates which are pathogenic to neurons which method comprises administering to said mammal an amount of a polyisoprenyl phosphonate derivative which will inhibit neural death and increase neural activity, or impede the progression of the neural disease.

Negative effects of neural diseases that are inhibited or reduced by a polyisoprenyl phosphonate derivative according to this invention include but are not limited to Alzheimer's disease, Parkinson's disease, multiple sclerosis, prion diseases such as Kuru, Creutzfeltdt-Jakob disease, Fatal familial insomnia, and Gerstmann-Straussler-Scheinker syndrome, amyotrophic lateral sclerosis, or damage to the spinal cord. The polyisoprenyl phosphonate derivatives described herein are also contemplated to prevent neural death during epileptic seizure.

It is further contemplated that the polyisoprenyl phosphonate derivatives and/or compositions containing the same can be used for the treatment of osteopenia osteoporosis.

### EXAMPLES

The following examples are given for the purpose of illustrating various embodiments of the invention and are not meant to limit the present invention in any fashion. The present examples, along with the methods described herein are presently representative of preferred embodiments, are exemplary, and are not intended as limitations on the scope of the invention. Changes therein and other uses which are encompassed within the spirit of the invention as defined by the scope of the claims will occur to those skilled in the art.

From the foregoing it will be appreciated that, although specific embodiments of the invention have been described herein for purposes of illustration, various modifications may be made without deviating from the spirit and scope of the invention.

Throughout the description of this invention, reference is made to various patent applications and publications, each of which are herein incorporated by reference in their entirety.

### Example 1

### Synthetic Examples

### Preparation of Compound 2

[chemical structure]

To a solution of 1 (300 mg, 1.03 mmol) and pyridine (40 mg, 0.51 mmol) in n-hexane (20 mL) at −20° C. was added dropwise PBr₃ (150 mg, 0.55 mmol). The reaction mixture was warmed to rt and stirred for 16 h, then water (10 mL) was added. The aqueous phase was extracted with ethyl ether (20 mL×2) and the combined organic layers were dried over Na₂SO₄ and concentrated, the residue 2 (380 mg, 99%) was used for next step without further purification. TLC R_{f}=0.7 (petroleum ether (PE), visualized with KMnO₄); ¹H NMR (400 MHz, CDCl₃) δ5.54 (t, J=8.4 Hz, 1H), 5.11-5.10 (m, 3H), 4.03 (d, J=8.4 Hz, 2H), 2.06-2.13 (m, 12H), 1.76 (s, 3H), 1.70 (s, 3H), 1.61 (s, 9H).

### Preparation of Compound 4

[chemical structure]

To a suspension of NaH (60%, 43 mg, 1.07 mmol) in anhydrous DMF (5 mL) at 0° C. was added 3 (310 mg, 1.07 mmol). The reaction mixture was stirred for 30 minutes, then 2 (380 mg, 1.07 mmol) was added. The reaction mixture was warmed to rt and stirred for 1 h, then water (5 mL) was added. The aqueous phase was extracted with ethyl ether (20 mL×2) and the combined organic layers were dried over Na₂SO₄ and concentrated, the residue was purified by flash column on silica (dichloromethane (DCM):MeOH=100:0-50:1) to give 4 (230 mg, 44%). LC-MS: 561.5 (M+1)⁺; TLC R_{f}=0.3 (DCM:MeOH=20:1, KMnO₄); ¹H NMR (400 MHz, CDCl₃) δ5.32 (t, J=6.8 Hz, 1H), 5.11-5.10 (m, 3H), 4.21-4.14 (m, 8H), 2.70-2.60 (m, 2H), 2.39-2.26 (m, 1H), 2.07-1.96 (m, 12H), 1.68 (s, 3H), 1.65 (s, 3H), 1.60 (s, 9H), 1.33 (t, J=7.0 Hz, 12H).

### Preparation of Compound 5

[chemical structure]

To a solution of 4 (200 mg, 0.36 mmol) in DCM (20 mL) was added 2,4,6-collidine (0.15 mL) and TMSBr (0.45 mL) at room temperature. The reaction mixture was stirred for 16 h. The solvent was removed. The residue was dissolved in methanol, followed by the addition of NaOH (200 mg, 5 mmol). The obtained mixture was stirred for 30 minutes and concentrated. The residue was dissolved in water and extracted with DCM. The aqueous phase was adjusted to pH=1 with concentrated HCl and extracted with ethyl acetate (EA), washed with brine, dried over Na₂SO₄, concentrated to give 5 (80 mg, 50%). LC-MS: 447.4 (M−1)⁻; ¹H NMR (400 MHz, CD₃OD) δ5.42 (t, J=7.2 Hz, 1H), 5.13-5.08 (m, 3H), 2.67-2.61 (m, 2H), 2.16-1.96 (m, 13H), 1.69-1.59 (m, 15H).

### Preparation of Compound 6

[chemical structure]

To a suspension of NaH (60%, 20 mg, 0.48 mmol) in anhydrous THF at 0° C. was added 15-crown-5 (60 mg, 0.27 mmol) followed by 3 (130 mg, 0.45 mmol). The reaction mixture was stirred for 30 minutes and 2 (420 mg, 1.18 mmol) was added. The reaction mixture was warmed to rt and stirred for 1 h, then water (5 mL) was added. The aqueous phase was extracted with ethyl ether (20 mL×2) and the combined organic layers were dried over Na₂SO₄ and concentrated, the residue was purified by flash column on silica (DCM:MeOH=100:0-50:1) to give 6 (230 mg, 75%). TLC R_{f}=0.4 (DCM:MeOH=20:1, KMnO₄); ¹H NMR (400 MHz, CDCl₃) δ5.43 (t, J=6.8 Hz, 2H), 5.14-5.10 (m, 6H), 4.21-4.13 (m, 8H), 2.63 (dt, J=16.0, 6.8 Hz, 4H), 2.07-1.96 (m, 24H), 1.68 (s, 6H), 1.62 (s, 6H), 1.60 (s, 18H), 1.33 (t, J=6.8 Hz, 12H).

### Preparation of Compound 7

[chemical structure]

To a solution of compound 6 (230 mg, 0.46 mmol) in DCM (3 mL) at 0° C. was added 2,4,6-collidine (0.12 mL, 0.92 mmol, 4.0 equ), and TMSBr (0.37 mL, 2.8 mmol, 12 equ). The mixture was stirred at 0° C. for 1 h, and at rt for 12 h. The reaction mixture was concentrated. To the residue was added methanol (5 mL), followed by the addition of NaOH (300 mg, 7.5 mmol). The obtained mixture was stirred for 30 minutes and concentrated: The residue was dissolved in water and extracted with DCM. The aqueous phase was adjusted to pH 1 with concentrated HCl and extracted with EA, washed with brine, dried over Na₂SO₄, and concentrated. The residue was purified by C₁₋₁₈ column to provide 7 (34 mg, 13%) as an oil. LC-MS: 719.4 (M−1)⁻; TLC R_{f}=0.2 (DCM:MeOH=20:1, KMnO₄); ¹H NMR (CDCl₃, 300 MHz) 5.34 (s, 2H), 5.09 (s, 6H), 2.66 (m, 2H), 2.03-1.97 (m, 24H), 1.58 (m, 24H).

### Preparation of Compound 8

[chemical structure]

To a suspension of NaH (60%, 177 mg, 4.43 mmol) in anhydrous THF (20 mL) at 0° C. was added 15-crown-5 (160 mg, 0.73 mmol) followed by 3 (500 mg, 1.74 mmol). The reaction mixture was stirred for 30 minutes and geranyl bromide (942 mg, 4.34 mmol) was added. The reaction mixture was warmed to rt and stirred for 1 h, and then water (5 mL) was added. The aqueous phase was extracted with ethyl ether (30 mL×2) and the combined organic layers were dried over Na₂SO₄ and concentrated, the residue was purified by flash column on silica (DCM:MeOH=100:0-50:1) to give 8 (700 mg, 72%). LC-MS: 561.6 (M+1)⁺; TLC R_{f}=0.4 (DCM:MeOH=20:1, KMnO₄); ¹H NMR (400 MHz, CDCl₃) δ5.40 (t, J=6.8 Hz, 2H), 5.10 (t, J=6.8 Hz, 2H), 4.19-4.12 (m, 8H), 2.62 (dt, J=16.0, 7.2 Hz, 4H), 2.08-1.98 (m, 8H), 1.66 (s, 3H), 1.61 (s, 3H), 1.59 (s, 3H).

### Preparation of Compound 9

[chemical structure]

To a solution of 8 (600 mg, 1.07 mmol) in 20 ml of DCM was added 2,4,6-collidine (0.4 mL) and TMSBr (1.2 mL). The reaction mixture was stirred for 16 h. The solvent was removed. The residue was dissolved in methanol, followed by the addition of NaOH (300 mg, 7.5 mmol). The obtained mixture was stirred for 30 minutes and concentrated. The residue was dissolved in water and extracted with DCM. The aqueous phase was adjusted to pH 1 with concentrated HCl and extracted with EA, washed with brine, dried over Na₂SO₄, concentrated to give 9 (200 mg, 42%). LC-MS: 447 (M−1)⁻; ¹H NMR (400 MHz, CDCl₃) δ8.89 (br s, 4H), 5.34 (br s, 2H), 5.06 (br s, 2H), 2.66-2.65 (m, 4H), 2.07-1.99 (m, 8H), 1.64 (s, 3H), 1.58 (s, 3H), 1.56 (s, 3H).

### Preparation of Compound 10

[chemical structure]

To a suspension of NaH (60%, 40 mg, 1 mmol) in anhydrous DMF at 0° C. was added 3 (288 mg, 1 mmol). The reaction mixture was stirred for 30 minutes and farnesyl bromide (285 mg, 1 mmol) was added. The reaction mixture was warmed to rt and stirred for 1 h, then water (5 mL) was added. The aqueous phase was extracted with ethyl ether (20 mL×2) and the combined organic layers were dried over Na₂SO₄ and concentrated, the residue was purified by flash column on silica (DCM:MeOH=100:0-50:1) to give 10 (310 mg, 63%). LC-MS: 493.4 (M+1)⁺; TLC R_{f}=0.3 (DCM:MeOH=20:1, KMnO₄); ¹H NMR (400 MHz, CDCl₃) δ5.30 (t, J=7 Hz, 1H), 5.11-5.06 (m, 2H), 4.20-4.12 (m, 8H), 2.68-2.56 (m, 2H), 2.36-2.24 (m, 1H), 2.10-1.91 (m, 8H), 1.66 (s, 3H), 1.63 (s, 3H), 1.58 (s, 3H), 1.57 (s, 3H), 1.32 (dt, J=7.2, 1.6 Hz, 12H).

### Preparation of Compound 11

[chemical structure]

To a solution of 10 (270 mg, 0.63 mmol) in 20 ml of DCM was added of 2,4,6-collidine (0.2 mL) and TMSBr (0.6 mL) and the reaction mixture was stirred for 16 h. The solvent was removed. The residue was dissolved in methanol, followed by the addition of NaOH (200 mg, 5 mmol). The obtained mixture was stirred 30 minutes and concentrated. The residue was dissolved in water and extracted with DCM. The aqueous was adjusted to pH 1 with concentrated HCl and extracted with EA, washed with brine, dried over Na₂SO₄, concentrated to give 11 (30 mg, 12%). LC-MS: 379.3 (M−1)⁻; ¹H NMR (400 MHz, CD₃OD) δ5.42 (t, J=7.2 Hz, 1H), 5.14-5.08 (m, 2H), 2.70-2.57 (m, 2H), 2.22-1.94 (m, 9H), 1.66 (s, 6H), 1.59 (s, 6H).

### Preparation of Compound 13 and 14

[chemical structure]

To a suspension of NaH (60%, 80 mg, 2 mmol) in anhydrous DMF at 0° C. was added 12 (450 mg, 2 mmol). The reaction mixture was stirred for 30 minutes and farnesyl bromide (570 mg, 2 mmol) was added. The reaction mixture was warmed to rt and stirred for 1 h, then water (5 mL) was added. The aqueous phase was extracted with ethyl ether (20 mL×2) and the combined organic layers were dried over Na₂SO₄ and concentrated, the residue was purified by flash column on silica (DCM:MeOH=100:0-50:1) to give 13 (400 mg, 48%) and 14 (160 mg, 13%).

Compound 13: LC-MS: 429.3 (M+1)⁺; TLC R_{f}=0.3 (PE:EA=3:1, KMnO₄); ¹H NMR (400 MHz, CDCl₃) δ 5.07-5.04 (m, 3H), 4.21-4.11 (m, 6H), 2.98-2.89 (m, 1H), 2.72-2.64 (m, 1H), 2.52-2.47 (m, 1H), 2.05-1.94 (m, 8H), 1.74 (s, 3H), 1.70 (s, 3H), 1.66 (s, 3H), 1.64 (s, 3H), 1.40 (dt, J=7.2, 2.4 Hz, 6H), 1.33 (t, J=7 Hz, 3H).

Compound 14: LC-MS: 655.5 (M+Na)⁺; TLC R_{f}=0.4 (PE:EA=3:1, KMnO₄); NMR (400 MHz, CDCl₃) δ 5.16 (t, J=6.8 Hz, 2H), 5.05-5.02 (m, 4H), 4.17-4.05 (m, 6H), 2.61-2.54 (m, 4H), 2.02-1.89 (m, 16H), 1.62 (s, 6H), 1.53-1.56 (m, 18H), 1.28-1.20 (m, 9H).

### Preparation of Compound 15

[chemical structure]

To a solution of 13 (300 mg, 0.73 mmol) in 20 ml of DCM was added of 2,4,6-collidine (0.2 mL) and TMSBr (0.6 mL) and the reaction mixture was stirred for 16 h. The solvent was removed. The residue was dissolved in methanol, followed by the addition of NaOH (200 mg, 5 mmol). The obtained mixture was stirred for 30 minutes and concentrated. The residue was dissolved in water and extracted with DCM. The aqueous was adjusted to pH 1 with concentrated HCl and extracted with EA, washed with brine, dried over Na₂SO₄, concentrated to give 15 (100 mg, 37%). LC-MS: 373.2 (M+1)⁺; ¹H NMR (400 MHz, CD₃OD) δ 5.11-5.06 (m, 3H), 4.20-4.03 (m, 2H), 2.72-2.63 (m, 2H), 2.56-2.49 (m, 1H), 2.05-1.91 (m, 8H), 1.65 (s, 3H), 1.64 (s, 3H), 1.58 (s, 3H), 1.57 (s, 3H), 1.23 (t, J=7 Hz, 3H).

### Preparation of Compound 16 and 17

[chemical structure]

To a suspension of NaH (60%, 40 mg, 1 mmol) in anhydrous DMF (5 mL) at 0° C. was added 12 (250 mg, 1.02 mmol). The reaction mixture was stirred for 30 minutes and 2 (300 mg, 0.85 mmol) was added. The reaction mixture was warmed to rt and stirred for 1 h, and then water (5 mL) was added. The aqueous phase was extracted with ethyl ether (20 mL×2) and the combined organic layers were dried over Na₂SO₄ and concentrated, the residue was purified by flash column on silica (PE:EA=100:1-5:1) to give 16 (230 mg, 76%) and 17 (100 mg, 16%).

Compound 16: LC-MS: 497.6 (M+1)^{+:} TLC R_{f}=0.3 (PE:EA=3:1, KMnO₄): ¹H NMR (400 MHz, CDCl₃) δ 5.17-5.05 (m, 4H), 4.22-4.12 (m, 6H), 2.99-2.90 (m, 1H), 2.75-2.65 (m, 1H), 2.56-2.48 (m, 1H), 2.08-1.96 (m, 12H), 1.69 (s, 3H), 1.65 (s, 3H), 1.60 (s, 12H), 1.34 (dt, J=6.8, 2 Hz, 6H), 1.28 (t, J=7.2 Hz, 3H).

Compound 17: LC-MS: 791.9 (M+Na)⁺; TLC R_{f}=0.4 (PE:EA=3:1, KMnO₄); ¹H NMR (400 MHz, CDCl₃) δ 5.22 (t, J=7 Hz, 2H), 5.10 (br s, 6H), 4.25-4.10 (m, 6H), 2.67-2.60 (m, 4H), 2.07-1.95 (m, 24H), 1.68 (s, 6H), 1.62 (m, 6H), 1.60 (s, 18H), 1.33-1.26 (m, 9H).

### Preparation of Compound 18

[chemical structure]

To a solution of 16 (230 mg, 0.73 mmol) in DCM (3 mL) was added of 2,4,6-collidine (0.12 mL, 0.92 mmol) and TMSBr (0.37 mL, 2.8 mmol), and the reaction mixture was stirred for 16 h. The solvent was removed. The residue was dissolved in methanol. The obtained mixture was stirred for 30 minutes and concentrated. The residue was dissolved in aqueous NaHCO₃, and extracted with DCM. The aqueous was adjusted to pH 1 with concentrated HCl and extracted with EA, washed with brine, dried over Na₂SO₄, and concentrated. The residue was purified by C-18 column to give 18 (43 mg, 14%). LC-MS: 439.2 (M−1)⁻.

### General Procedure for Preparation of Compound 19

[chemical structure]

To a suspension of NaH (60%, 40 mg, 1 mmol) in anhydrous DMF (5 mL) at 0° C. was added 12 (220 mg, 1 mmol). The reaction mixture was stirred for 30 minutes and geranyl bromide (220 mg, 1 mmol) was added. The reaction mixture was warmed to rt and stirred for 1 h, then water (5 mL) was added. The aqueous phase was extracted with ethyl ether (20 mL×2) and the combined organic layers were dried over Na₂SO₄ and concentrated, the residue was purified by flash column on silica (DCM:MeOH=100:0-50:1) to give 19 (120 mg, 33%). LC-MS: 361.5 (M+1)⁺; TLC R_{f}=0.3 (PE:EA=3:1, KMnO₄); ¹H NMR (400 MHz, CDCl₃) δ5.13-5.05 (m, 2H), 4.23-4.11 (m, 6H), 2.96-2.87 (m, 1H), 2.69-2.63 (m, 1H), 2.57-2.51 (m, 1H), 2.13-1.99 (m, 5H), 1.74 (s, 3H), 1.70 (s, 3H), 1.64 (s, 3H), 1.36-1.26 (m, 9H).

| Example | |
|---|---|
| Number | Structure |
| 4 | [chemical structure] |
| 5 | [chemical structure] |
| 6 | [chemical structure] |
| 7 | [chemical structure] |
| 8 | [chemical structure] |
| 9 | [chemical structure] |
| 10 | [chemical structure] |
| 11 | [chemical structure] |
| 13 | [chemical structure] |
| 14 | [chemical structure] |
| 15 | [chemical structure] |
| 16 | [chemical structure] |
| 17 | [chemical structure] |
| 18 | [chemical structure] |
| 19 | [chemical structure] |

### Example 2

### Inhibition of Osteoclast Differentiation and Activation In Vitro and In Vivo

Osteoclasts are large multinucleated cells derived from the myelomoncitic lineage that adhere to and resorb bone through the local production of the lytic enzymes cathepsin K and tartrate-resistant acid phosphatase (TRAP), which degrade bone protein and mineral content. Osteoclasts can be isolated from animal bones or can be generated from myeloid precursors via differentiation in vitro. Myeloid cells treated in vitro with the cytokines Colony-Stimulating Factor-1 (CSF-1) and receptor activator of nuclear factor kappa-B ligand (RANKL) (Boyle, W. J. et al., Nature 423(6937):337-42, 2003) differentiate into mature osteoclasts that express Cathepsin K and TRAP and are capable of resorbing cortical bone slices. Compounds that are used to treat bone diseases characterized by pathologic bone loss either block osteoclast differentiation and/or osteoclast activation of bone resorption.

### A: Effect of GGA on Osteoclastogenesis

To determine the effect of geranylgeranylacetone (GGA) on osteoclastogenesis, osteoclast precursors are derived by taking the nonadherent bone marrow cells after an overnight incubation in CSF-1/M-CSF (macrophage colony stimulating factor), and culturing the cells for an additional 4 days with 1,000-2,000 U/ml CSF-1. (Lacey et al., Cell 93, 165-176, 1998). Following 4 days of culture, the adherent cells, which are bone marrow macrophages, can then be exposed to 100 ng/ml RANKL and cultured for 3-5 days. [[THe]] The generation of mature osteoclast can be measured by counting multinucleated TRAP positive cells' or by measuring TRAP enzyme activity using histoperoxidase assays as described. Test agents such as GGA and derivatives can be added during this terminal period as well to determine their effects on osteoclast differentiation.

### B: Effects of GGA and GGA Derivatives on Bone Resorption In Vitro

To assess the effects of GGA and derivatives on bone resorption in vitro one can use the bone pit assay as described by Burgess et al. (J. Cell Biol. 145(3): 527-538, 1999). Osteoclasts can be differentiated on the surface or cortical or dentin bone slices in the presence of CSF-1 and RANKL, then treated with test compounds to look at the impact on bone resorption pit formation as described.

### C. Inhibition of Osteoclast Function In Vivo by Monitoring Bone Resorption

GGA and derivatives can be tested for their ability to modulate osteoclast function by administering to animals and monitoring bone resorption. One model is to determine the effects on bone resorption of young growing mice as previously described (Schenk et al., Calcif. Tissues Int 38:342-349, 1986; Simonet et al., Cell 89, 308-319, 1997). Young growing mice aged 3-4 weeks, weight range 9.2-15.7 g are divided into groups of ten mice per group. These mice are injected subcutaneously with saline or test compounds bid for 14 days (5 mg/kg/day). The mice are then radiographed before treatment, at day 7 and on day 14. The mice were sacrificed 24 hours after the final injection. The right femur is then removed, fixed in zinc formalin, decalcified in formic acid and embedded in paraffin. Sections are cut through the mid region of the distal femoral metaphysis and the femoral shaft. Bone density, by histomorphometry, is determined in six adjacent regions extending from the metaphyseal limit of the growth plate, through the primary and secondary spongiosa and into the femoral diaphysis (shaft). Radiographic changes are observed after seven days of treatment to detect evidence of a zone of increased bone density in the spongiosa associated with the growth plates in the GGA treated mice relative to that seen in the controls. Histological changes are observed in the distal femoral metaphysis as shown by increased bone density in a regions 1.1 to 2.65 mm in distance from the growth plate. This is a region where bone is rapidly removed by osteoclast-mediated bone resorption in mice. In these rapidly growing young mice, the increase in bone in this region observed with treatment is consistent with an inhibition of bone resorption.

### D: Effects of GGA and GGA Derivatives on Bone Loss in Ovariectomized Rats

Effects of GGA and derivatives on bone loss can also be assessed in ovariectomized rats, an animal model for postmenopausal osteoporosis. In this model, typically twelve week old female Fisher rats are ovariectomized (OVX) or sham operated and dual x-ray absorptiometry (DEXA) measurements are made of, the bone density in the distal femoral metaphysis. After 3 days recovery period, the animals receive daily injections for 14 days as follows: Ten sham operated animals receive vehicle (phosphate buffered saline); Ten OVX animals receive vehicle (phosphate buffered saline); Six OVX animals receive test compounds; Six OVX animals receive pamidronate (PAM) 5 mg/kg SC as a positive control bisphosphonate; Six OVX animals receive estrogen (ESTR) 40 ug/kg SC. After 7 and 14 days post treatment the animals have bone density measured by DEXA. Two days after the last injection the animals are sacrificed and the right tibia and femur removed for histological evaluation.

The DEXA measurements of bone density will allow detection of a trend to reduce bone density following ovariectomy that is modulated by test compounds and positive controls. The histomorphometric analysis of these animals will confirm bone density increases due to the preservation of cortical bone due to inhibition of osteoclast mediated bone resorption.

All abbreviations used herein have their ordinary scientific meaning as known to the skilled artisan. EA=ethyl acetate and DCM=dichloromethane.

1. A composition for inhibiting neural death, increasing neural activity and/or for reducing one or more negative effects of neurodegeneration comprising a compound of Formula (I) or Formula (H): [chemical structure]
or a pharmaceutically acceptable salt thereof, and at least one pharmaceutically acceptable excipient,
wherein
R¹ is C₅-C₂₀ alkyl or C₅-C₂₀ alkenyl optionally substituted with 1-3 C₆-C₂₀ arylene groups in the chain and that is optionally substituted with 1-3 halo, trifluoromethyl, —OR⁷, —P(═O)(OR⁸)(OR⁹) or —NR¹⁰R¹¹ groups;
R² is (C₅-C₂₀)alkyl or C₅-C₂₀ alkenyl optionally substituted with 1-3 C₆-C₂₀ aryl groups, which aryl group(s) are optionally substituted with 1-3 halo, trifluoromethyl, —OR⁷, —P(═O)(OR⁸)(OR⁹) or —NR¹⁰R¹¹ groups;
each R³, R⁴, R⁵, and R⁶ is independently OH or C₁-C₆ alkoxy;
each R⁷, R⁸ and R⁹ is independently hydrogen, C₁-C₆ alkyl or C₅-C₂₀ aryl; and
each R¹⁰ and R¹¹ is independently hydrogen, C₁-C₆ alkyl or C₆-C₂₀ aryl; or R¹⁰ and R¹¹ together with the nitrogen to which they are attached form a C₃-C₇ heterocycle;
wherein each aryl group of R⁷, R⁸, R⁹, R¹⁰ and R¹¹ is optionally substituted with 1-3 C₁-C₆ alkyl, C₁-C₆ alkoxy, C₁-C₆ alkanoyl, C₁-C₆ alkanoyloxy, C₁-C₆ alkoxycarbonyl, halo, cyano, nitro, carboxy, tritluoromethyl, trifluoromethoxy. NR¹²R¹³, or S(O)₂NR¹²R¹³ groups, wherein each R¹² and R¹³ is independently hydrogen or C₁-C₆ alkyl;
R¹⁴ and R¹⁵ are independently selected from the group consisting of hydrogen, C₁-C₆ alkyl, C₃-C₇ cycloalkyl, C₂-C₆ alkenyl, C₁-C₆ alkynyl, optionally substituted C₆-C₂₀ aryl, optionally substituted C₆-C₂₀ aryl-C₁-C₆alkyl, optionally substituted heteroaryl and optionally substituted heteroaryl-C₁-C₆ alkyl, each heteroaryl having 2-14 ring carbon atoms and 1-6 ring heteroatoms selected preferably from N, O, S, and P, wherein each substituted aryl or substituted heteroaryl is independently substituted with 1-3 substituents selected from —OH, halo, C₁-C₆ alkyl, C₁-C₆ alkoxy, and —NR¹⁰R¹¹ groups; or R¹⁴ and R¹⁵ together with the carbon atom they are attached to form a C₃-C₇ cycloalkyl ring optionally substituted with 1-3 C₁-C₆ alkyl groups;
R¹⁶ and R¹⁷ independently are hydrogen or C₁-C₆ alkyl;
each R¹⁸ and R¹⁹ are independently selected from the group consisting of a hydrogen, C₁-C₆ alkyl, and a group of Formula (III): [chemical structure]
wherein R¹⁴-R¹⁷ and n are as defined as herein;
Y is —P(═O)(OR¹⁸)(OR¹⁹) or —CO₂R²⁰, wherein R²⁰ is selected from the group consisting of a hydrogen and C₁-C₆ alkyl;
Z is [chemical structure]
wherein R²¹ is hydrogen or C₁-C₆ alkyl; A is C₁-C₅ alkylene which may have a substituent selected from —OH, halo, C₁-C₆ alkyl, and C₁-C₆ alkoxy groups on each carbon;
r is 0, 1, 2, 3, 4 or 5; and
n is 0, 1, 2, 3, 4 or 5.

2. The composition of claim 1, wherein the compound of Formula I is of Formula (IIA) [chemical structure]
wherein R¹⁴, R¹⁵, R¹⁸ and R¹⁹ are defined as in claim 1.

3. The composition of claim 1, wherein the compound of Formula (II) is selected from the group consisting of:

[chemical structure]

4. The composition or claim 1, wherein the compound of Formula (I) is selected from the group consisting of:

[chemical structure]

5. A compound of Formula (II): [chemical structure]
or a pharmaceutically acceptable salt thereof,
wherein
R¹⁴ and R¹⁵ are independently selected from the group consisting of hydrogen, C₁-C₆ alkyl, C₃-C₇ cycloalkyl, alkenyl, C₁-C₆ alkynyl, optionally substituted C₆-C₂₀ aryl, optionally substituted C₆-C₂₀ aryl-C₁-C₆ alkyl, optionally substituted heteroaryl and optionally substituted heteroaryl C₆ alkyl, each heteroaryl having 2-14 ring carbon atoms and 1-6 ring heteroatoms selected preferably from N, O, S, and P, wherein each substituted aryl or substituted heteroaryl is independently substituted with 1-3 substituents selected from —OH, halo, C₁-C₆ alkyl, C₁-C₆ alkoxy, —NO₂, and groups; or
R¹⁴ and R¹⁵ with the carbon atom they are attached to form a C₃-C₇ cycloalkyl ring optionally substituted with 1-3 C₁-C₆ alkyl groups;
R¹⁶ and R¹⁷ independently are hydrogen, methyl or C₂-C₆ alkyl, provided that, when one of R¹⁸ and R¹⁹ is not: [chemical structure]
and each of R¹⁶ and R¹⁷ is methyl, then R′⁴ and R¹⁵ together with the carbon atom they are attached to form a C₅-C₇ cycloalkyl optionally substituted with 1-3 C₁-C₆ alkyl groups;
R¹⁸ and R¹⁹ are independently selected from the group consisting of a hydrogen, C₁-C₆ alkyl and a group of Formula (III): [chemical structure]
Y is —P(═O)(OR¹⁸)(OR¹⁹) or
—CO₂R²⁰, wherein R²⁰ is selected from the group consisting of hydrogen and C₁-C₆ alkyl;
Z is [chemical structure]
wherein R²¹ is hydrogen or C₁-C₆ alkyl; A is C₁-C₅ alkylene which may have a substituent selected from —OH, halo, C₁-C₆ alkyl, and C₁-C₆ alkoxy groups on each carbon;
r is 0, 1, 2, 3, 4 or 5; and
n is 0, 1, 2, 3, 4 or 5.

6. A composition comprising the compound of claim 5 and at least one pharmaceutically acceptable excipient.

7. A method for inhibiting neural death, increasing neural activity, and/or of reducing one or more negative effects of neurodegeneration comprising administering a compound of claim 5 to a patient in need thereof.

8. A method for treating osteopenia and/or reducing one or more negative effects of osteopenia comprising administering an effective amount of a compound of claim 5 to a patient in need thereof.

9. A method for inhibiting neural death, increasing neural activity, and/or of reducing one or more negative effects of neurodegeneration comprising administering to a patient in need thereof an effective amount of a compound of formula (I) or (II) selected from the group consisting of:

[chemical structure]

10. A method for treating osteopenia and/or reducing one or more negative effects of osteopenia comprising administering to a patient in need thereof an effective amount of a compound of formula (I) or (II) selected from the group consisting of:

[chemical structure]

11. A method for inhibiting neural death, increasing neural activity, and/or of reducing one or more negative effects of neurodegeneration comprising administering a composition of claim 6 to a patient in need thereof.

12. A method for treating osteopenia and/or reducing one or more negative effects of osteopenia comprising administering an effective amount of a composition of claim 6 to a patient in need thereof.
